(19) United States
(12) Patent Application Publication
(10) Pub. No.: US 2003/0048358 A1
(43) Pub. Date: Mar. 13, 2003

(54) Digital camera recycle system

(76) Inventor: Hideyuki Shirai, Tenri-shi (JP)

Correspondence Address: BIRCH STEWART KOLASCH & BIRCH, PO BOX 747, FALLS CHURCH, VA, 22040-0747, US

(21) Appl. No.: 10/241,446

(22) Filed: Sep. 12, 2002

(30) Foreign Application Priority Data
Sep. 12, 2001 (JP) 2001-276067(P)

(51) Int. Cl. H04N 5/225

(52) U.S. Cl. 348/207.1

(57) ABSTRACT

In a digital camera recycle system, image data of an image picked-up by a digital camera is encoded by the digital camera. The coded image data is decoded at a sales side terminal based on information transmitted from a server apparatus, and provided to the user. One business proprietor may manage (operate) the server apparatus and the sales side terminal as well as manufacture and sales of the digital camera. Alternatively, the consumer may use his/her own personal computer in place of the sales side terminal, to receive service to obtain image information, at a specific site provided by the server apparatus operated by the business proprietor.

### BACKGROUND OF THE INVENTION

1. Field of the Invention

The present invention relates to a camera recycle system, an information processing unit, a digital camera and to a camera recycle method. More specifically, the present invention relates to a digital camera recycle system, an information processing unit, a digital camera and a digital camera recycle method that enable recycling of digital cameras.

2. Description of the Background Art

Cameras using films have been conventionally recycled, as disposable cameras (film-with-lens) are recovered when the films of the disposable cameras on which images are picked-up by the users are developed and printed. Such recycling of cameras using films is widely popular.

Recently, not only cameras using films but also digital cameras have been in wide use. In a digital camera, images can be erased by electronic operation, and wear-out parts at the time of recycling are smaller in number. Therefore, the digital camera is more suitable for recycling than the cameras using films. Accordingly, a business model of rental digital camera at a rental shop where the user establishes his/her identity, and a business model in which an image recorded on a memory device is printed at a multimedia terminal installed at a convenience store, for example, have been proposed.

In recycling cameras using films, there are disadvantages that the number of wear-out parts is large as mentioned above and that the films remaining at the time of development cannot be used, as compared with recycling of digital cameras. From this view point, recycling of digital cameras would be advantageous. Further, the digital camera inherently has an advantage over the camera using films that the picked-up images can be transmitted in the form of data, that is, in the form that can be easily sent to others. The digital camera further has an advantage that the time necessary for printing the picked-up image on a photographic paper is shorter than that for the cameras using films. In other words, the digital camera is advantageous over the camera with films that the picked-up image or image data can more conveniently be handled. In this point also, recycling of digital cameras would be advantageous.

In the conventionally proposed techniques for recycling digital cameras, identification was required for rental, or rental fee of the digital camera body was high. Therefore, it has been difficult to easily and casually handle the digital cameras in the manner as the disposable cameras, on the road or at a convenience store, or by an automatic vending machine or the like. Namely, the conventional recycling of digital cameras has not been simple and easy for consumers. The reason for this was that parts constituting the body of the digital camera such as an image pick-up device, a data processing circuit and a memory device were expensive, and hence it was difficult to lend out digital cameras to the users easily and casually.

### SUMMARY OF THE INVENTION

The present invention was made in view of the foregoing, and its object is to enable digital camera recycling in a simple manner, in a digital camera recycle system.

According to an aspect, a digital camera recycle system of the present invention is directed to a digital camera recycle system including a digital camera and an information processing unit connectable to the digital camera. In this system, the digital camera includes an image pick-up optical system, an original image data preparing portion for preparing original image data by processing an image signal obtained by the image pick-up optical system, a coded data preparing portion for preparing coded image data by encoding the original image data, and a coded data output portion for outputting the coded image data to the information processing unit. In the system, the information processing unit includes a decoded data preparing portion for decoding the coded image data, when a prescribed condition is satisfied.

According to this aspect of the present invention, in a digital camera, the generated image is encoded. For decoding the coded image data, a process at the information processing unit is necessary. Therefore, a system can be established, in which the image data generated by the digital camera cannot be properly output unless a prescribed condition is satisfied in the information processing unit.

Accordingly, it is possible for a business proprietor performing digital camera rental operation to charge the user in accordance with the manner of output, every time the image data generated by the digital camera is output. Therefore, the rental cost of the digital camera itself can be suppressed. Thus, the digital camera rental operation becomes easy and convenient for the user.

In the digital camera recycle system of the present invention, the information processing unit includes a terminal apparatus connectable to the digital camera, and a server apparatus having a decoded data preparing portion and connectable to the terminal apparatus through a network. Further, in the system, the terminal apparatus includes an input portion for inputting a condition for decoding the coded image data.

According to another aspect of the present invention, the information processing unit is connected to a digital camera including an image pick-up optical system, an original image data preparing portion preparing original image data by processing an image signal obtained by the image pick-up optical system, a coded data preparing portion for preparing coded image data by encoding the original image data, and a coded data output portion for outputting the coded image data to an external apparatus. Further, the information processing unit includes a receiving portion for receiving the coded image data from the coded data output portion, and a decoded data preparing portion for decoding the coded image data, when a prescribed condition is satisfied.

According to this aspect of the present invention, in a digital camera, the generated image is encoded. For decoding the coded image data, a process at the information processing unit is necessary. Therefore, a system can be established, in which the image data generated by the digital camera cannot be properly output unless a prescribed condition is satisfied in the information processing unit.

Accordingly, it is possible for a business proprietor performing digital camera rental operation to charge the user in accordance with the manner of output, every time the image data generated by the digital camera is output. Therefore, the rental cost of the digital camera itself can be suppressed. Thus, the digital camera rental operation becomes easy and convenient for the user.

The information processing unit of the present invention preferably includes a terminal apparatus connectable to a digital camera, and a server apparatus including a decoded data preparing portion and connectable to the terminal apparatus through a network, and the terminal apparatus preferably includes an input portion for inputting a condition for decoding the coded image data.

Preferably, in the information processing unit of the present invention, the decoded data preparing portion includes a decoding logic circuit.

Further, in the information processing unit of the present invention, preferably, the coding logic circuit is implemented by a tamper resistant apparatus.

Preferably, the information processing unit of the present invention further includes a coding key preparing portion for preparing a coding key, used for coding in the digital camera and decoding at the data preparing portion.

Preferably, the information processing unit of the present invention further includes a first database storing first digital camera information including information for identifying each digital camera, and a digital camera information updating portion for updating the first digital camera information.

Preferably, in the information processing unit of the present invention, the first digital camera information includes second digital camera information which is information particular to each digital camera and invariable even when the first digital camera information is updated.

Further, in the information processing unit of the present invention, the digital camera preferably includes a coded image data storing portion storing the coded image data, the digital camera information updating portion updates the first digital camera information in response to erasure of all the contents stored in the coded image data storing portion, the coding key preparing portion prepares a coding key in response to erasure of all the contents stored in the coded image data storing portion and transmits the prepared coding key to the digital camera, and the digital camera information preparing portion transmits the prepared first digital camera information to the digital camera, in response to erasure of all the contents stored in the coded image data storing portion.

Preferably, the information processing unit of the present invention includes a second database storing information selected by the user in relation to output of image data obtained by the digital camera, a third database storing information related to output fee of image data obtained by the digital camera, and a fourth database storing information related to output fee when output is made in accordance with information selected by the user in relation to output of the image data obtained by the digital camera, calculated based on the information stored in the second database and information stored in the third database.

Preferably, the information processing unit of the present invention further includes a fee calculating portion calculating information related to output fee, when output is made in accordance with information selected by the user in relation to output of image data obtained by the digital camera, based on the information stored in the second database and the information stored in the third database.

According to a still further aspect, the digital camera of the present invention includes an image pick-up optical system, an original image data preparing portion preparing original image data by processing an image signal obtained by the image pick-up optical system, and a coded data preparing portion for preparing coded image data by encoding the original image data.

According to this aspect of the present invention, in a digital camera, the generated image is encoded. For decoding the coded image data, a process at the information processing unit is necessary. Therefore, a system can be established, in which the image data generated by the digital camera cannot be properly output unless a prescribed condition is satisfied in the information processing unit.

Accordingly, it is possible for a business proprietor performing digital camera rental operation to charge the user in accordance with the manner of output, every time the image data generated by the digital camera is output. Therefore, the rental cost of the digital camera itself can be suppressed. Thus, the digital camera rental operation becomes easy and convenient for the user.

Preferably, in the digital camera of the present invention, the coded data preparing portion is implemented by a tamper resistant apparatus.

Preferably, the digital camera of the present invention further includes a transmitting portion transmitting coded image data to an external apparatus.

Preferably, the digital camera of the present invention further includes an identification information storing portion storing information for identifying each digital camera, and the transmitting portion transmits the coded image data to an external apparatus on condition that information for identifying the digital camera stored in the identification information storing portion is input.

Preferably, in the digital camera of the present invention, the contents stored in the identification information storing portion is rewritable when a prescribed condition is satisfied.

Preferably, in the digital camera of the present invention, the contents stored in the identification information storing portion is rewritable every time a prescribed condition is satisfied.

Further, in the digital camera of the present invention, the information for identifying each digital camera preferably includes digital camera management information for specifying the digital camera, a digital camera ID updated when a prescribed condition is satisfied, a coding key used for preparation of coded image data and decoding, and the maximum recordable number of images that can be picked-up by the digital camera.

Preferably, the digital camera of the present invention is provided to the user as ready-to-use, with information identifying each digital camera being stored in the identification information storing portion.

According to a still further aspect, the present invention provides, in a system including a digital camera and an information processing unit connectable to the digital camera, a method of recycling a digital camera, including the steps of generating original image data by processing an image signal obtained by an image pick-up optical system of the digital camera, in the digital camera, coding the original image data by the digital camera, and decoding the coded image data by the information processing unit, when a prescribed condition is satisfied.

According to the aspect of the present invention, in a digital camera, the generated image is encoded. For decoding the coded image data, a process at the information processing unit is necessary. Therefore, a system can be established, in which the image data generated by the digital camera cannot be properly output unless a prescribed condition is satisfied in the information processing unit.

Accordingly, it is possible for a business proprietor performing digital camera rental operation to charge the user in accordance with the manner of output, every time the image data generated by the digital camera is output. Therefore, the rental cost of the digital camera itself can be suppressed. Thus, the digital camera rental operation becomes easy and convenient for the user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows an entire configuration of a recycle digital camera system in accordance with an embodiment of the present invention.

FIG. 2 shows a detailed configuration of the server apparatus shown in FIG. 1.

FIG. 3 schematically shows the contents stored in the first storing apparatus shown in FIG. 2.

FIGS. 4 to 6 represent, in the form of tables, stored contents of various digital cameras, in the first storing apparatus of FIG. 2.

FIG. 7 schematically shows the contents stored in the second storing apparatus shown in FIG. 2.

FIGS. 8 to 10 represent, in the form of tables, work files based on the database shown in FIG. 7.

FIG. 11 schematically shows an example of image data before encoding.

FIG. 12 schematically shows an example of coded image data.

FIG. 13 schematically shows the contents stored in a third storing apparatus shown in FIG. 2.

FIG. 14 represents, in the form of a table, contents stored in the third storing apparatus shown in FIG. 2.

FIG. 15 schematically represents contents stored in the fourth storing apparatus shown in FIG. 2.

FIGS. 16A to 16C represent, in the form of tables, work files based on the database of FIG. 15.

FIG. 17 shows a detailed configuration of the control apparatus shown in FIG. 1.

FIGS. 18A and 18B show appearance of the digital camera of FIG. 1.

FIG. 19 is a block diagram of the digital camera shown in FIGS. 18A and 18B.

FIG. 20 schematically shows the contents stored in an ID storing apparatus shown in FIG. 19.

FIG. 21 represents, in the form of a table, contents stored in the ID storing apparatus shown in FIG. 19.

FIG. 22 represents, in the form of a table, contents stored in an image memory of FIG. 18.

FIG. 23 shows a detailed configuration of sales side terminal.

FIG. 24 shows a detailed configuration of a personal computer of FIG. 23.

FIG. 25 is a flow chart of the process in which the digital camera shown in FIG. 1 is manufactured, subjected to registration before shipment and shipped.

FIG. 26 represents detailed contents of processing for the registration before shipment of the digital camera, by a manufacturer/seller shown in FIG. 25.

FIG. 27 represents detailed contents of the process for purchasing and image pick-up of the digital camera 1 shown in FIG. 25.

FIG. 28 is a flow chart of a subroutine for forming and recording coded image data shown in FIG. 27.

FIGS. 29 to 31 are flow charts showing, in detail, contents of image data output at the sales side terminal of FIG. 25.

FIGS. 32 and 33 represent examples of the images displayed on an operation panel (display screen) of the sales side terminal shown in FIG. 1.

FIG. 34 is a flow chart of the subroutine of the process for forming/recording decoded image data of FIG. 31.

FIG. 35 shows an example of the image displayed on the operation panel (display screen) of the sales side terminal of FIG. 1.

FIGS. 36 and 37 are flow charts of the subroutine of the digital camera recycle process, through a network of FIG. 25.

### DESCRIPTION OF THE PREFERRED EMBODIMENTS

[Overall System Configuration]

A recycle digital camera system in accordance with an embodiment of the present invention will be described in the following, with reference to the figures.

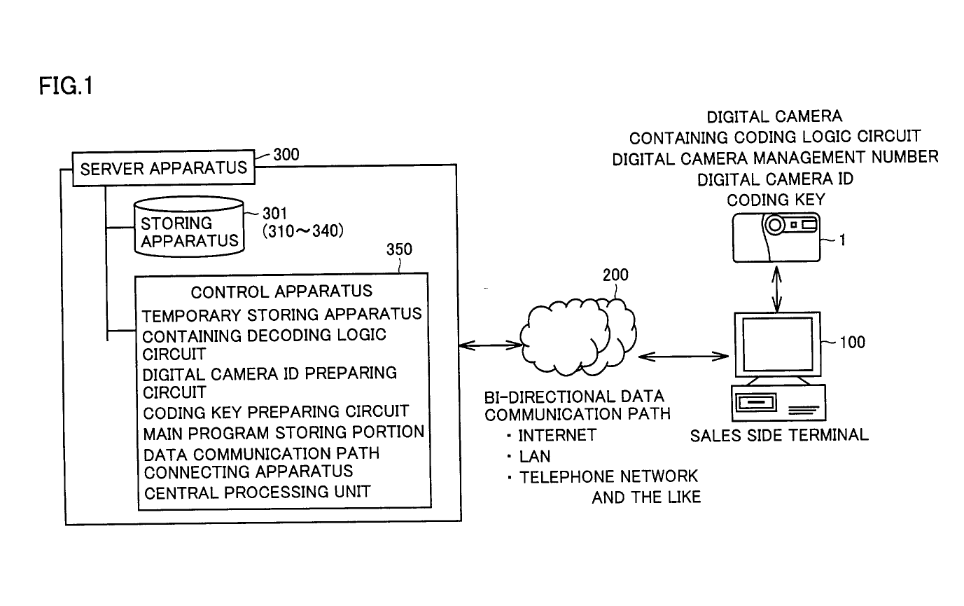

Referring to FIG. 1, a recycle digital camera system includes a server apparatus 300, a sales side terminal 100, a digital camera 1 and a bi-directional data communication path 200.

Sales side terminal 100 and server apparatus 300 may be implemented by a general purpose computer, for example. Information can be transmitted/received between sales side terminal 100 and server apparatus 300 through bi-directional data communication path 200. Bi-directional data communication path 200 may be implemented by a general network such as the Internet, LAN (Local Area Network), telephone line or the like. Digital camera 1 is connectable to the sales side terminal 100.

In the system of the present embodiment, image data of the picked-up image is encoded in digital camera 1. The coded image data is decoded in sales side terminal 100 based on information transmitted from server apparatus 300, and provided to the user.

One business proprietor may manage (operate) server apparatus 300 and sales side terminal 100, manufacture and sale digital camera 1. Alternatively, a consumer may access to a specific site provided by server apparatus 300 operated by a business proprietor, through his/her personal computer in place of the sales side terminal 100, and receive the service, that is, purchase image information.

The recycle digital camera system of the present embodiment is to re-use digital camera 1, which is used for image pick-up by the user, by connecting the digital camera 1 from sales side terminal 100 through bi-directional data communication path 200 to server apparatus 300 so as to process (print/erase and so on) the image data stored in digital camera 1. The manner of recycle includes “continued use by a consumer”, “recycled use by a consumer” and “return”. User may select which manner is to be taken, at the sales side terminal 100.

The continued use by a consumer means that the present user reuses the digital camera 1 as it is. This is selected, for example, when it is still possible to pick up a large number of images by the digital camera (number of recordable images is large).

The recycled used by a consumer refers to erasure of image data recorded in digital camera 1 to enable re-use of the digital camera 1. For example, this manner is selected when the number of recordable images left in digital camera 1 is small, for example, 0.

Return (manufacturer recycle) refers to returning of digital camera 1 by the user to the manufacturer or business proprietor. In this case, the manufacturer, seller or the proprietor cancels/deletes image data recorded in digital camera 1 and exchanges parts of digital camera 1, and thereafter, the digital camera 1 is shipped again.

[Configuration of Server Apparatus]

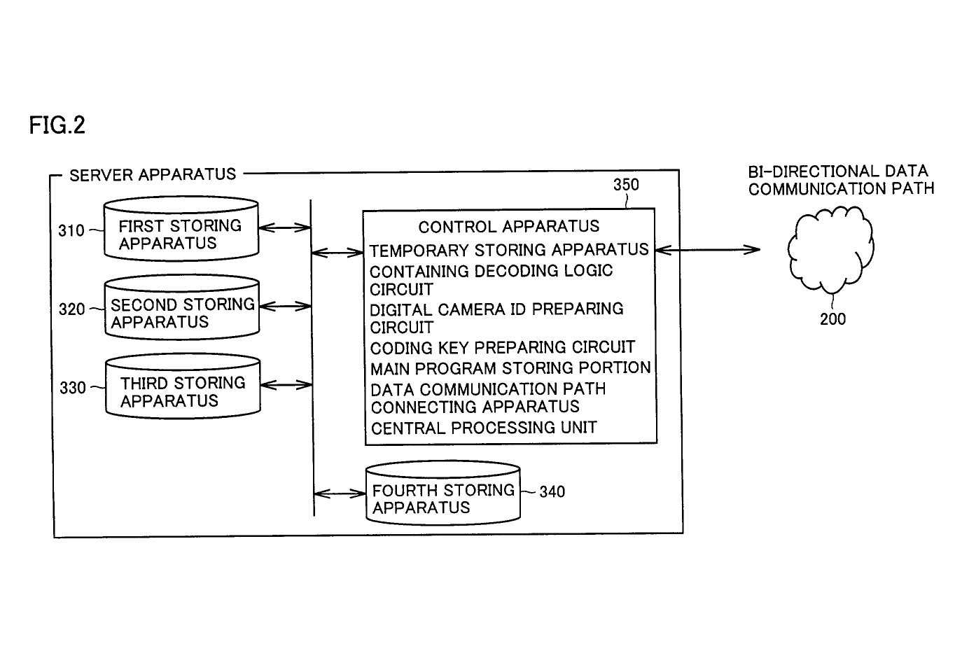

Referring to FIG. 2, server apparatus 300 includes a first storing apparatus 310, a second storing apparatus 320, a third storing apparatus 330, a fourth storing apparatus 340 and a control apparatus 350. These apparatuses are connected to each other by a bus in server apparatus 300. The first to fourth storing apparatuses 310, 320, 330 and 340 are generally represented by storing apparatus 301 in FIG. 1.

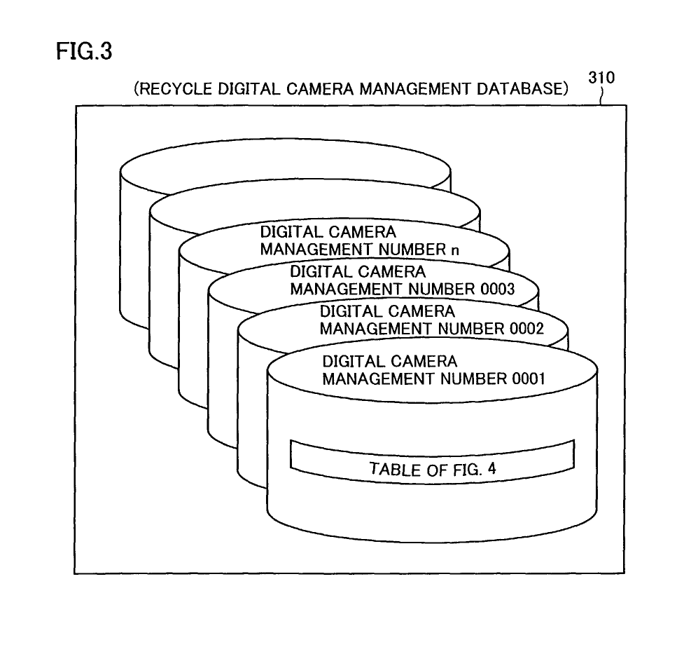

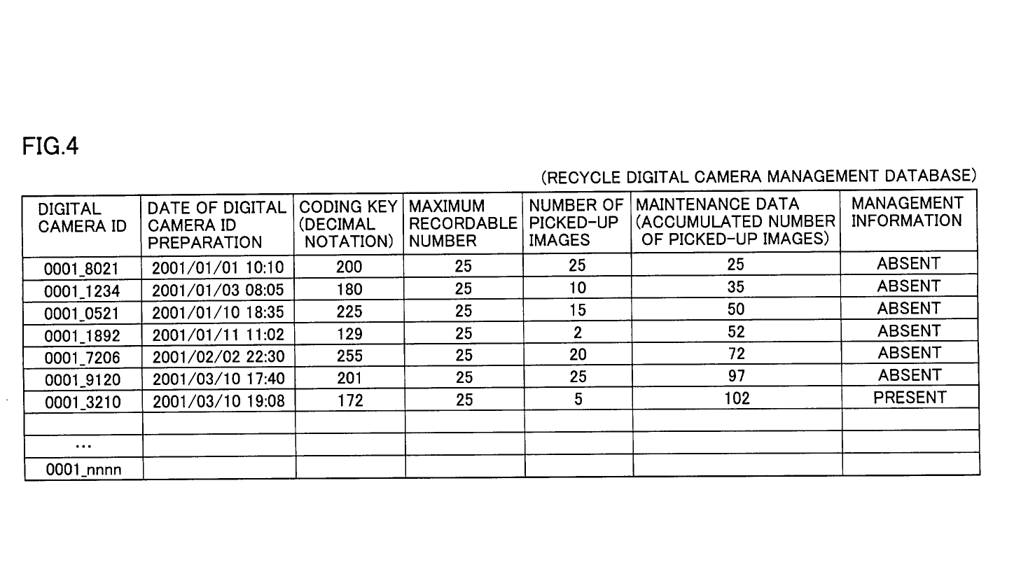

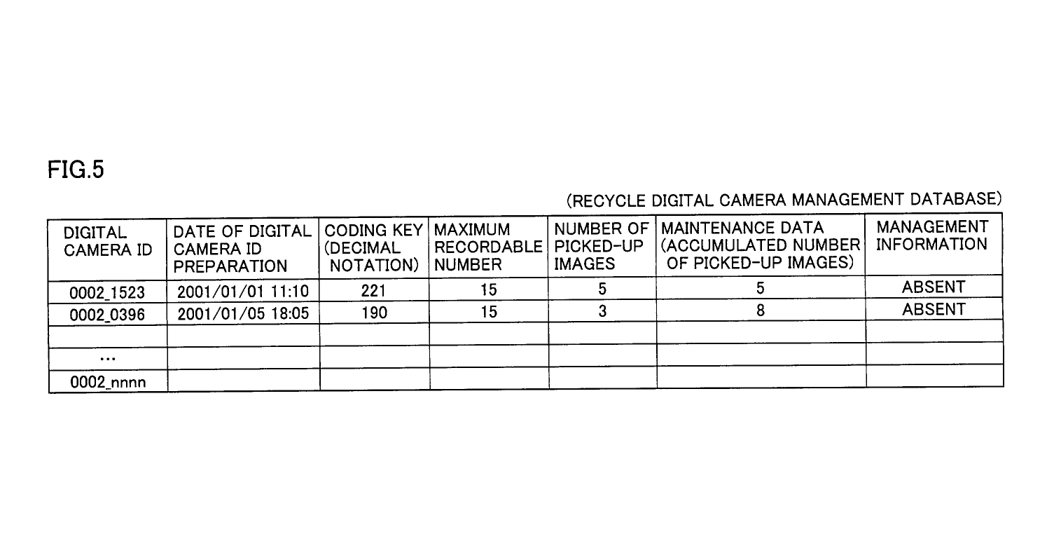

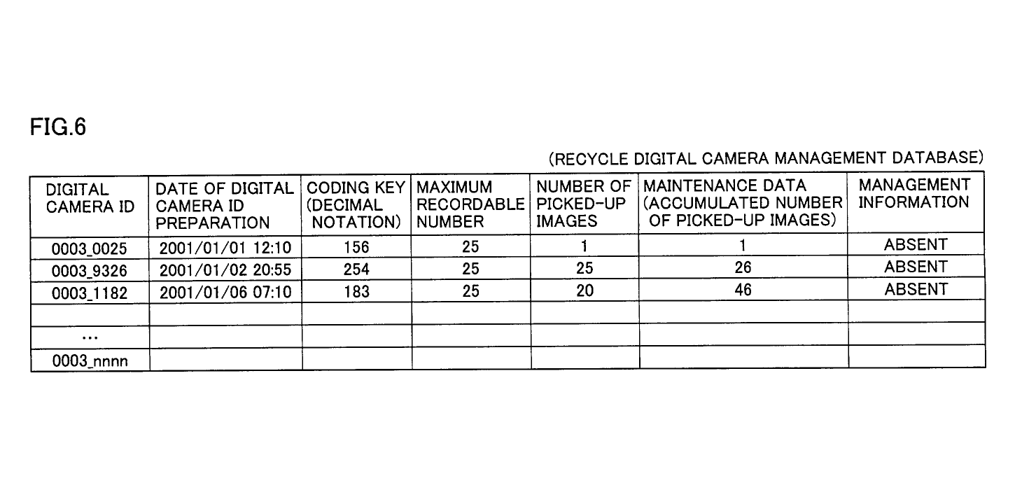

Referring to FIG. 3, the first storing apparatus 310 stores, for each digital camera management number, a recycle digital camera management database. The digital camera management number is a number for identifying each digital camera 1. FIGS. 4 to 6 represent, in the form of tables, the recycle digital camera management databases for respective digital cameras 1. The digital camera management number is not limited to a series of numerals, and it may be a string of characters including, for example, a symbol. FIG. 4 corresponds to digital camera 1 having the digital camera management number 0001, FIG. 5 corresponds to the digital camera 1 having digital camera management number 0002, and FIG. 6 corresponds to the digital camera 1 having digital camera management number 0003.

The recycle digital camera management database stores a digital camera ID, a digital camera ID preparation date, a coding key, maximum recordable number, number of picked-up images, maintenance data and management information, associated with each other.

The digital camera ID consists of a digital camera management number and a numeral of n digits. When a digital camera 1 is shipped to a user, image pick-up data of digital camera 1 recorded in a storage apparatus of digital camera 1 (image memory 20 and a digital camera ID storing apparatus 16, which will be described later) are deleted and recycled. At that time, the digital camera ID is updated to a different numeral. Digital camera ID constitutes first digital camera information. The first digital camera information is not limited to a series of numerals such as the digital camera ID of the present embodiment. It may be a series of characters, including a symbol or the like.

Referring to FIGS. 4 to 6, in the recycle digital camera management database, the digital camera ID is associated with various pieces of information, and therefore, when data transmission/reception is performed between each of server apparatus 300, sales side terminal 100 and digital camera 1, the transmission/reception can be performed while identifying which digital camera 1 is intended for data transmission/reception.

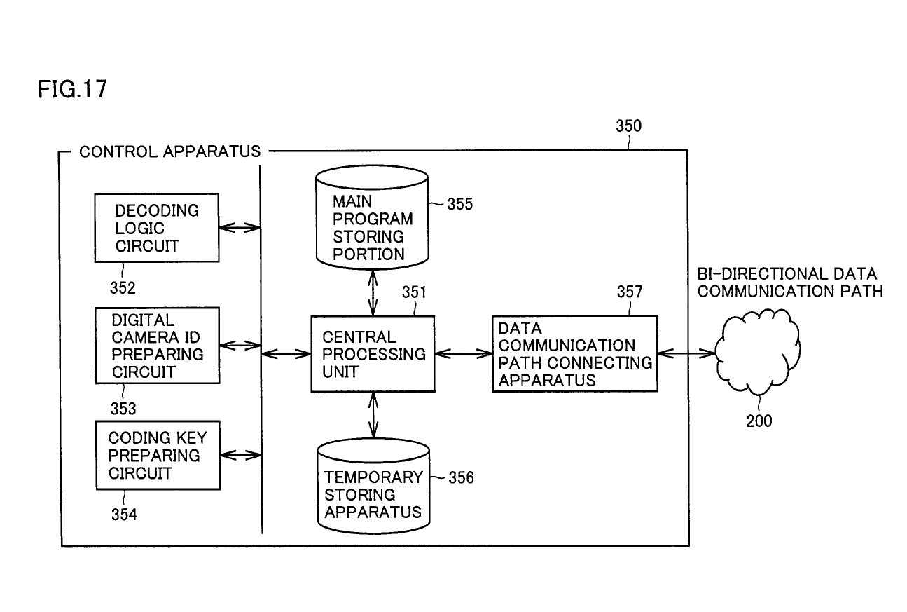

The digital camera ID preparation date represents the date on which digital camera ID was prepared, in a digital camera ID preparing circuit 353 (see FIG. 17) of control apparatus 350.

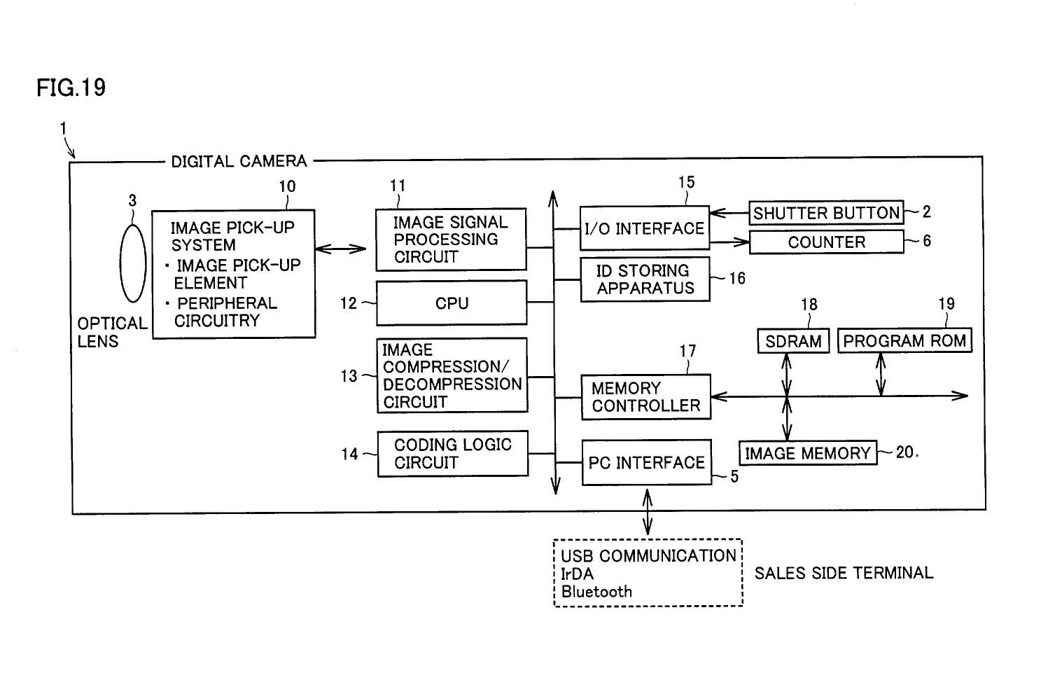

The coding key consists of numerals of m digits, and it is recorded in ID storing apparatus 16 (see FIG. 19) in digital camera 1, when digital camera 1 is shipped to the user. The coding key is used as a keyword for encoding and decoding image data.

The maximum recordable number represents maximal number of image data that can be recorded in digital camera 1, and it is recorded in ID storing apparatus 16 in digital camera 1 at the time of shipment of the digital camera. The maximum recordable number is set based on image data capacity per one image of digital camera 1 and the capacity of image memory 20 (see FIG. 19) of digital camera 1.

The number of picked-up images represents the number of images picked-up while the digital camera 1 operates under the present digital camera ID. The number of picked-up images is recorded in ID storing apparatus 16 in digital camera 1, and transmitted from digital camera 1 through sales side terminal 100 and bi-directional data communication path 200 to server apparatus 300.

The maintenance data (accumulated number of picked-up images) represents total sum of the picked-up images for each digital camera ID, of each digital camera 1. In other words, it represents accumulated number of images picked-up by the digital camera having the corresponding digital camera management number.

As the management information, data such as “condition satisfied” is input by the process of a main program of server apparatus 300 when the maintenance data (accumulated number of picked-up images) reaches a predetermined value. As such a data is input as the management information, it is possible in the present embodiment to notify the necessity of maintenance operation of digital camera 1, every time a prescribed number of images have been picked-up, by each digital camera 1. In the present embodiment, the accumulated number of picked-up images is input as the maintenance data, and therefore, the degree of wear of digital camera 1 can be notified for management, by the accumulated number of picked-up images.

The accumulated number of picked-up images is an example of the items that may be used for management of wear-out parts of the digital camera 1. The number of use of electronic flash or the number of erasure of image data in digital camera 1, for example, may be input as the maintenance data.

The information stored in the recycle digital camera management database described with reference to FIGS. 3 to 6 is information assisting management of digital camera 1 by server apparatus 300, and other pieces of information may be stored.

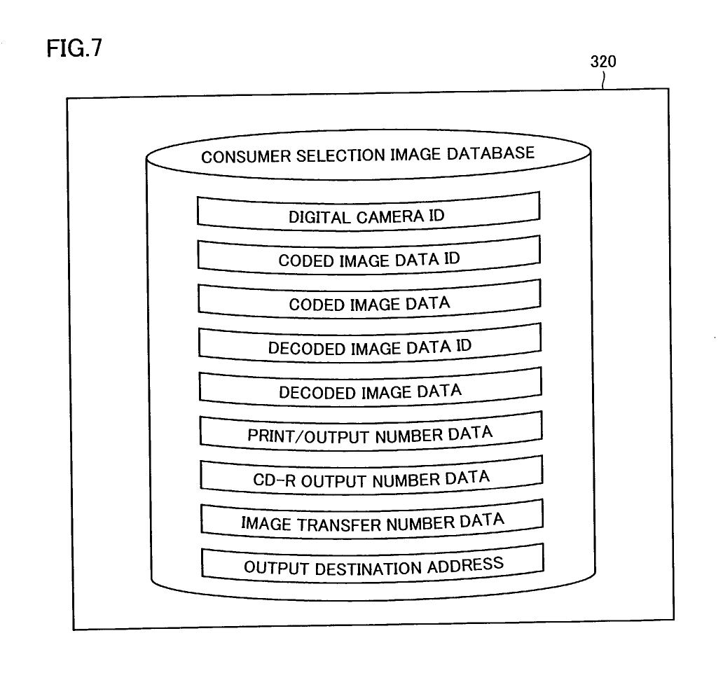

Referring to FIG. 7, consumer selection image database is stored in a second storing apparatus 320. The consumer selection image database refers to a database for preparing a work file in a temporary storing apparatus of sales side terminal 100 and of server apparatus 300, to enable sharing of data input by the consumer through the sales side terminal 100 and the data calculated in server apparatus 300, when bi-directional data communication is performed between the sales side terminal 100 connected to digital camera 1 and the server apparatus 300. The work file prepared in the temporary storing apparatus of each of the sales side terminal 100 and server apparatus 300 will be referred to as a consumer selection image work file.

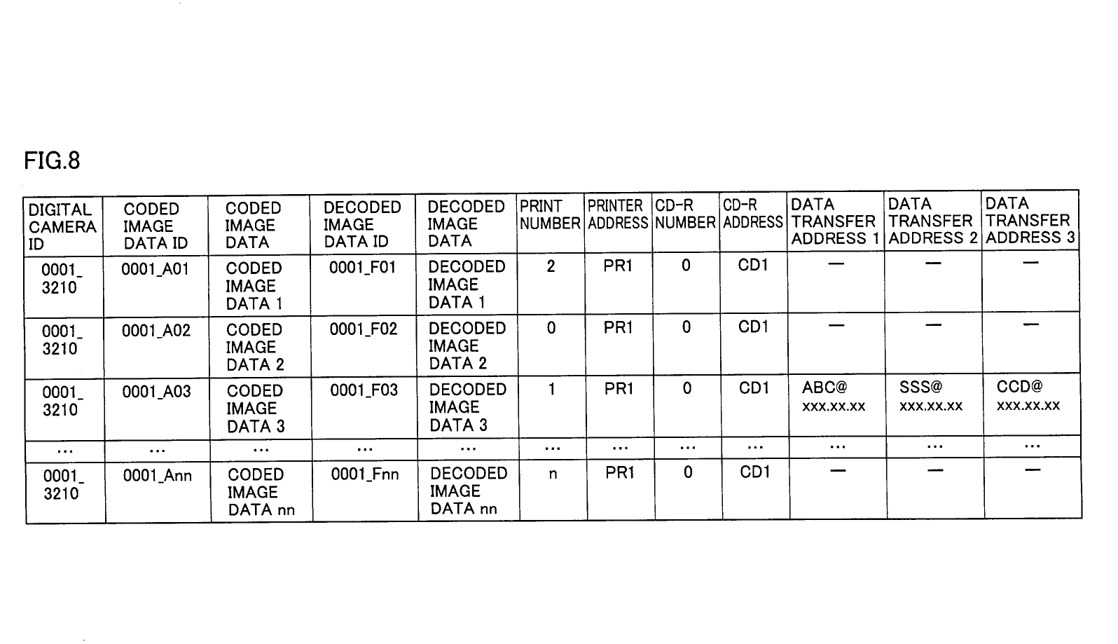

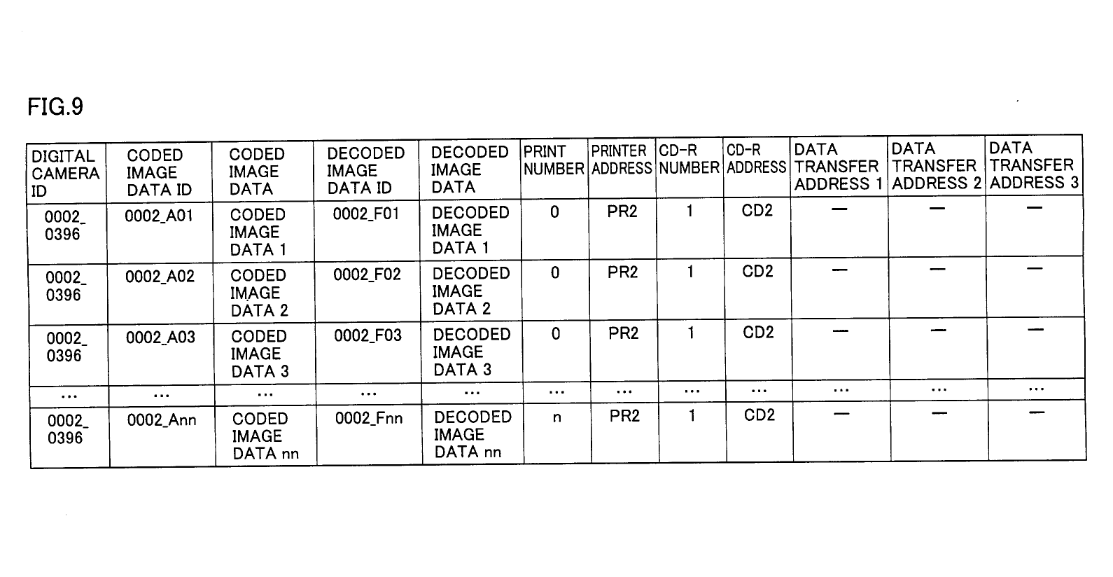

Referring to FIGS. 8 to 10, the consumer selection image work file includes digital camera ID, coded image data ID, coded image data, decoded image data ID, decoded image data, print number, printer address, CD-R number, CD-R address and data transfer addresses 1 to 3. FIGS. 8, 9 and 10 represent the consumer selection image work files of digital cameras having the digital camera management numbers 0001, 0002, 0003, respectively.

The digital camera ID consists of the digital camera management number and a numeral of m digits, and is recorded in ID storing apparatus 16 (see FIG. 19) in the digital camera, at the time of shipment of the digital camera.

The coded image data ID consists of the digital camera management number, the character A and a serial number from 1 to the maximum recordable number. The coded image data ID associates the digital camera 1 with the coded image data recorded in image memory 20 (see FIG. 19) of the digital camera 1.

The coded image data represents coded image data transferred from digital camera 1 through sales side terminal 100. The coded image data is configured as block data, with each pixel block data having 8 pixels×8 pixels. In other words, the image data having 352 pixels×288 pixels includes 44×36 pixel blocks, for example. The number of pixels that constitute one pixel block is not limited thereto. The coded image data is given within the range of 0 to 255 and it may assume various values dependent on the picked-up object. The value is provided as digital data of 8 bits of the pixel data.

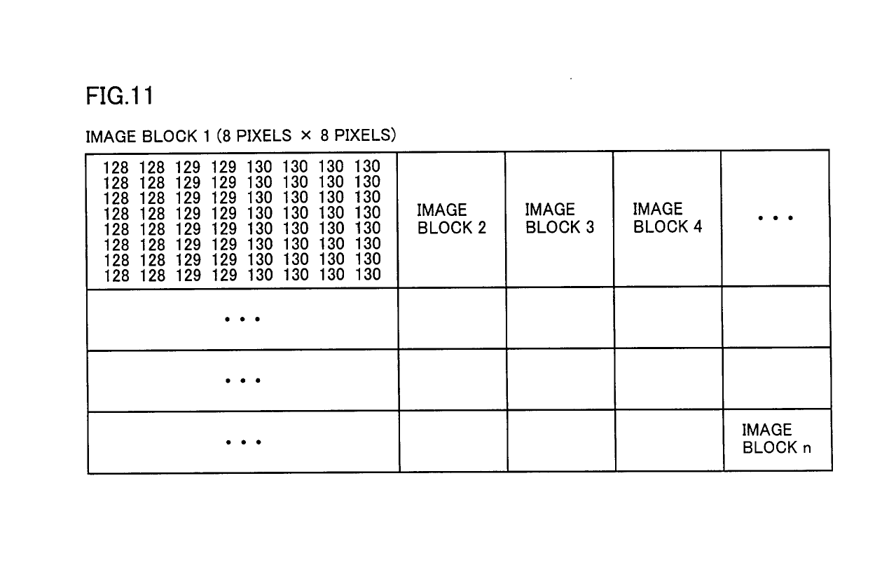

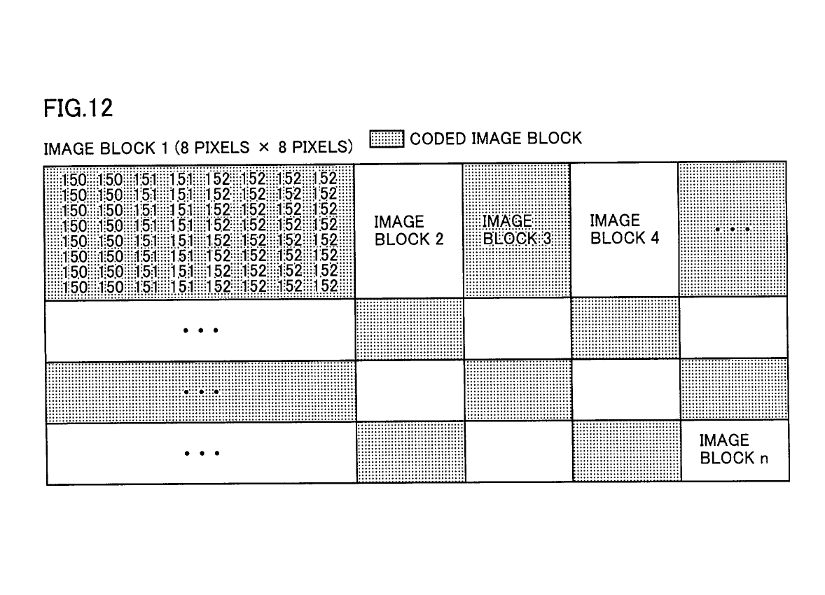

Referring to FIGS. 11 and 12, the image data is divided into a plurality of blocks, with each block having 8 pixels×8 pixels. In each block, 8 pixel data exist along each of the lateral and longitudinal directions. In FIGS. 11 and 12, digital data of 8 bits is represented in decimal notation. In FIG. 12, coded blocks are hatched. The configuration of the coded image data is in compliance with JPEG (Join Photographic Experts Group), for example, which is a general image format, and only the data corresponding to the image portion may be coded.

Again referring to FIGS. 7 to 10, decoded image data ID consists of the digital camera management number, the character F used not for the coded image data, and a serial number from 1 to maximum recordable number, for associating the coded image data ID with the decoded image data.

The decoded image data represent image data that is the coded image data transferred from digital camera 1 through sales side terminal 100 (see FIG. 12) and decoded by server apparatus 300. The decoded image data corresponding to FIG. 12 substantially is the same as the image data represented in FIG. 11.

The print number represents the data regarding the number of output of the image data, that is, the number of images to be printed, which is selected and input through sales side terminal 100.

The printer address represents address data of the printer connected to sales side terminal 100. When the sales side terminal 100 is, for example, a multimedia terminal with a built-in printer installed at a convenience store, the address of the multimedia terminal is the printer address.

The CD-R number represents data regarding the number of output of the image data, that is, the number of CD-R to be output as desired by the consumer, which is selected and input through sales side terminal 100.

The CD-R address represents address data of an external recording media drive, connected to sales side terminal 100. When the sales side terminal is a multimedia terminal with built-in external recording media drive provided at a convenience store, for example, the address of the multimedia terminal is the CD-R address.

The data transfer addresses 1 to 3 represent addresses of output destination of the image data where the consumer wishes to transfer data, and input using sales terminal 100.

The print number, printer address, CD-R number, CD-R address and data transfer addresses may be considered as service contents to the consumer, when the consumer wishes to have image data output. The consumer selection image database may additionally include selection items such as the printer size (A4, for example), or sheet (label sheet, for example). Further, DVD (Digital Video Disc), a memory card or the like may be added as alternative recording media, and the number of transfer addresses may be 4 or more.

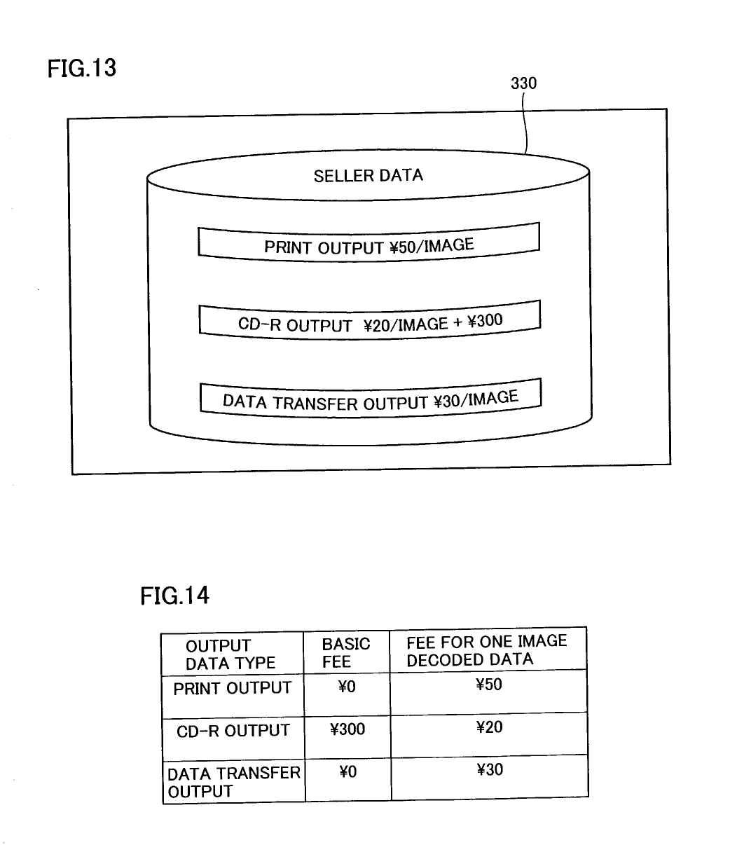

Referring to FIG. 13, seller data is recorded in a third storing apparatus 330. The seller data represents data regarding the amount of money required of the user when image data is output, determined by the seller operating the server apparatus 300 and the sales side terminal 100.

As can be seen from FIGS. 13 and 14, the seller data consist of output data type, basic fee, and fee for decoding one image data, associated with each other.

The output data type represents the data selected by the consumer as a form of image data output. Specifically, the type may include print output, CD-R output and data transfer output.

The basic fee represents a fixed amount of fee determined by the business proprietor for each of the output data type.

The fee for decoding one image data represents a fixed amount of fee per one image, determined by the business proprietor, for every output form data type.

The type of data output may not be limited to those shown in FIG. 14. As the output type, the size of print output or sheet type such as A4, service size, label sheet and the like may be added. Further, not only a photographing paper and CD-R but also a DVD and/or a memory card may be added as the output recording media.

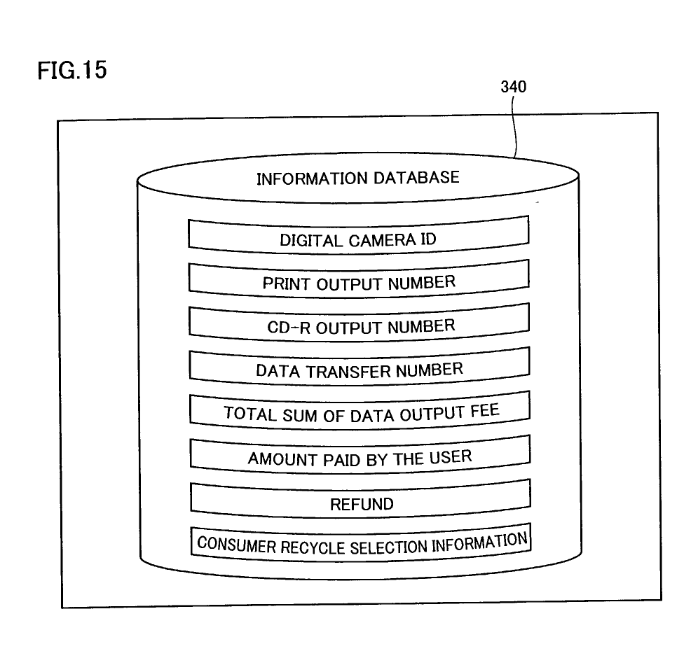

An information database such as shown in FIG. 15 is recorded in a fourth storing apparatus 340. The information database represents a database for preparing a work file in a temporary storing apparatus of sales side terminal 100 and of server apparatus 300, to make it possible for the consumer to share the data input to sales side terminal 100 and the data calculated by server apparatus 300, when bi-directional data communication is performed between sales side terminal 100 connected to digital camera 1 and the server apparatus 300.

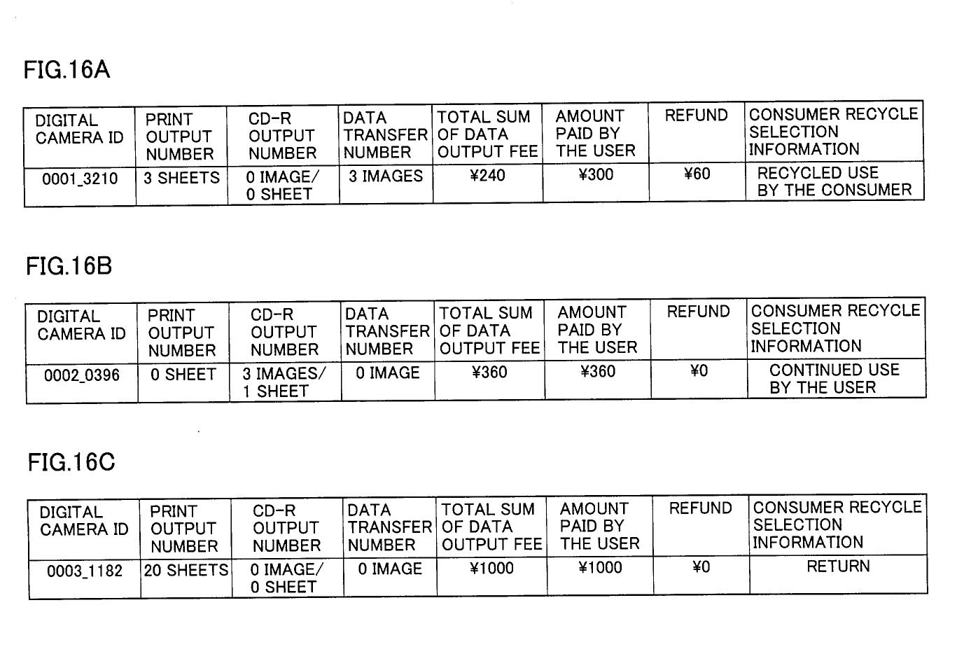

The work file prepared in the temporary storing apparatus of sales side terminal 100 and of server apparatus 300 prepared based on the information database is referred to as the information work file. FIGS. 16A, 16B and 16C represent information work files of digital camera management numbers 0001, 0002, and 0003, respectively.

The information work file consists of digital camera ID, print output number, CD-R output number, data transfer number, total data output fee, amount paid by the user, refund amount and consumer recycle selection information, associated with each other.

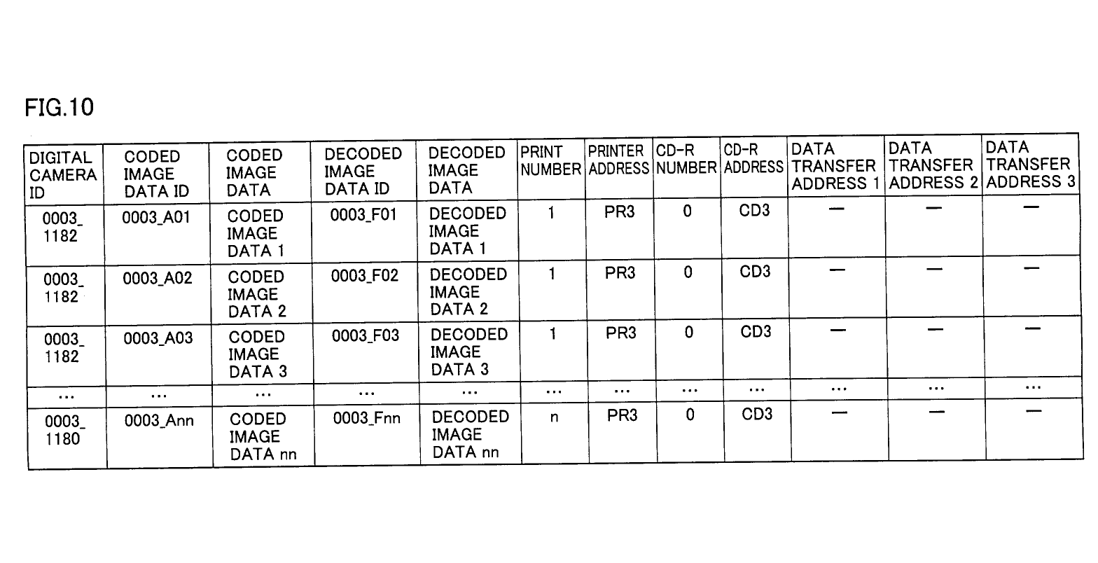

The digital camera ID is the same as the digital camera ID that has been described with reference to FIGS. 10 to 12.

The print output number represents the total number of image data selected to be print output by the consumer through sales side terminal 100, that is, the total print number in the consumer selection image work file of FIG. 10, for example.

The CD-R output number represents the total number of CD-R and the number of images of image data, selected to be CD-R output, by the consumer through sales side terminal 100. Here, the total of the number of images represents the number of CD-Rs of the consumer selection image work file of FIG. 10, for example, and the total of CD-R number represents the accumulated number of CD-Rs of the corresponding work file.

The data transfer number represents the total of image data selected to be output to the data transfer address by the consumer through sales side terminal 100, and it is the total of the data transfer address number of the consumer selection image work file shown in FIG. 10, for example.

The total data output fee represents the amount charged to the user for data output, and calculated by server apparatus 300 using seller data (see FIG. 14), in accordance with the print output number, CD-R output number and the data transfer number.

The amount paid by the user represents the charge data, paid by the consumer through an input system of a mechanical portion connected to sales side terminal 100. When sales side terminal 100 supports electronic account settlement system, it may be the amount data of the consumer that can be settled through the electronic accounting system.

The refund amount represents the data resulting from subtracting the charged data fee from the amount paid by the user.

Consumer recycle selection information represents data of the recycle manner of the digital camera 1, selected by the consumer.

The information stored in the information database assists management of user information of sales side terminal 100 by server apparatus 300, and other information may be stored.

Referring to FIG. 17, control apparatus 300 includes a decoding logic circuit 352, a digital camera ID preparing circuit 535, a coding key preparing circuit 354, a central processing unit 351, a data communication path connecting apparatus 357, a main program storing portion 355 storing a main program, and a temporary storing apparatus 356.

The decoding logic circuit 352 is a logic circuit having a function of decoding the data that has been coded by the coding logic circuit provided in the digital camera using a coding key, by using the same coding key. When the coding logic circuit 14 (see FIG. 19) of digital camera 1 is an addition logic, for example, the decoding logic circuit 352 is a subtraction logic circuit.

Digital camera ID preparing circuit 353 is for preparing the digital camera ID associated with the digital camera management number, by combining the digital camera management number and a numeral of n digits, and it is a circuit generating a random number of n digits.

The coding key preparing circuit 354 is a circuit generating a random number of m digits.

Central processing unit 351 performs control of various portions, selection of information, transfer of information, temporal storage of information and operation on information, in accordance with the main program stored in main program storing portion 355.

The temporary storing apparatus 356 temporarily holds results of processing of central processing unit 351 and so on. For example, it temporarily stores the consumer selection image work file and the information work file.

Data communication path connecting apparatus 357 is a control apparatus connected to sales side terminal 100 through bi-directional data communication path 200, for bi-directional communication.

Main program storing portion 355 is an apparatus for storing the main program. The main program is to realize instruction of decoding the coded image data, updating data in the first to fourth storing apparatuses 310 to 340, instruction to prepare digital camera ID to digital camera ID preparing circuit 353, instruction to prepare coding key to coding key preparing circuit 354, instruction to prepare the consumer selection image work file, instruction to prepare information file, and transmission/distribution of data, and the main program controls the overall server apparatus 300.

Therefore, the main program includes a plurality of programs such as those listed below.

1. A program for connection to a terminal through a data communication path, to enable bi-directional communication.

2. A program for storing the digital camera ID prepared by the digital camera ID preparing circuit, the date of preparation of the digital camera ID and the coding key prepared by the coding key preparing circuit in the first storing apparatus.

3. A program for storing information from the digital camera transferred through the sales side terminal in the first storing apparatus.

4. A program for storing the digital camera ID and the coded image data transferred from the digital camera through the sales side terminal in the temporary storing apparatus.

5. A program for storing print number, data transfer destination address or the like, selected by the consumer at the sales side terminal, in the temporary storing apparatus.

6. A program for decoding the coded image data stored in the temporary storing apparatus, by using the coding key corresponding to the digital camera ID stored in the first storing apparatus and a decoding logic circuit, and storing the result in the temporary storing apparatus.

7. A program performing an operation using the maintenance data (data of accumulated number of picked-up images) stored in the first storing apparatus and a value determined by the business proprietor, and for inputting data such as “condition satisfied” or “condition unsatisfied” as the management information of the first storing apparatus.

8. A program for operating information of the information work file stored in the temporary storing apparatus, based on the information of the seller data stored in the third storing apparatus and the consumer selection image work files stored in the temporary storing apparatus.

9. A program for transmitting/receiving information of the consumer selection image work file stored in the temporary storing apparatus, to the sales side terminal.

10. A program for transmitting/receiving information of the information work file stored in the temporary storing apparatus to the sales side terminal.

11. A program for instructing recycling of the digital camera to the sales side terminal and the digital camera through the bi-directional data communication path, in accordance with the consumer recycle selection information of the information work file stored in the temporary storing apparatus and the management information of the first storing apparatus.

The program listed as No. 11 may include

A. A program for instructing preparation of the digital camera ID and instructing preparation of the coding key, and storing the coding key in the first storing apparatus, when the consumer recycle selection information of the information work file stored in the temporary storing apparatus is “recycled use by the consumer” and management information of the first storing apparatus is “condition unsatisfied.”

B. A program distributing the digital camera ID of the latest date and time and the coding key of the latest date and time to the digital camera through the sales side terminal.

C. A program for instructing the sales side terminal to set the consumer recycle selection information to “return”, when the management information of the first storing apparatus is “condition satisfied.”

The main program may be stored in advance in main program storing portion 355, or it may be recorded on a recording medium that is detachable from server apparatus 300, such as a floppy (R) disc. When the program is recorded on a detachable recording medium, the recorded program is read from the recording medium by a recording medium drive such as a floppy (R) disc drive, and temporarily stored in the main program storing portion.

The recording medium recording the program may be any medium that holds a program fixedly, including a tape such as a magnetic tape or a cassette tape, a magnetic disc such as a flexible disk or a hard disk, an optical disk such as a CD-ROM (Compact Disk Read Only Memory), MO (Magneto Optical disk), MD (Mini Disk) or DVD, an IC (Integrated Circuit) card such as a memory card, a card such as an optical card or a semiconductor memory such as a mask ROM or a flash memory.

Further, the medium may be such a one that holds the program flexibly, for example, the program may be downloaded from the network. When the program is downloaded from the network as mentioned above, the program for downloading may be stored in advance in the server system, or installed in advance in the server system from a separate recording medium.

[Configuration of the Digital Camera]

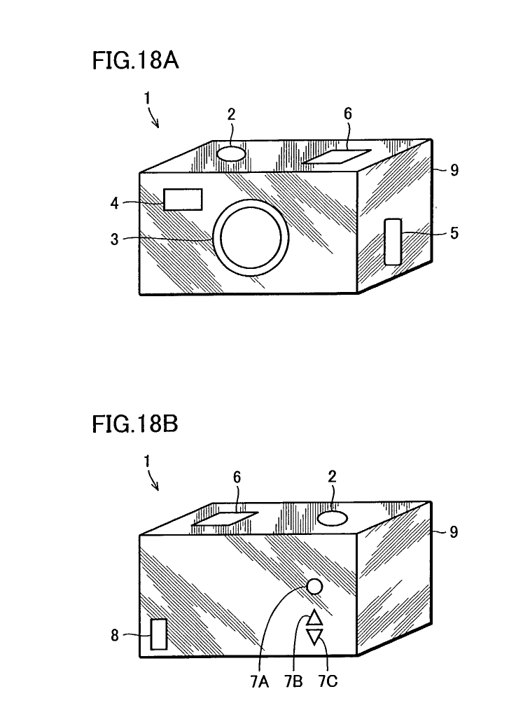

FIGS. 18A and 18B are perspective views of digital camera 1 viewed from the front and back sides, respectively.

The digital camera 1 includes a camera body 9, a shutter button 2, an optical lens 3, a finder 4, a PC connecting portion 5, a counter 6, operation buttons 7A to 7C, and a power switch 8. The user turns on power switch 8, confirms composition through finder 4 and presses shutter button 2, to pick up an image. The image obtained by the pick-up operation is subjected to signal processing and, thereafter, stored in an inner image memory. Counter 6 is counted up one by one at the time of image pick-up. Accordingly, the number of images stored in the internal image memory is indicated. The operation may be a countdown operation one by one from a predetermined number. When the counter value of counter 6 reaches a predetermined value, further image pick-up operation by digital camera 1 becomes impossible.

Referring to FIG. 19, digital camera 1 includes an image pick-up system 10, an image processing circuit 11, an image compression/decompression circuit 13, a coding logic circuit 14, an I/O interface 15, a CPU (Central Processing Unit) 12, an ID storing apparatus 16, a memory controller 17, an SDRAM (Synchronous Dynamic Random Access Memory) 18, a program ROM 19, an image memory 20 and a PC interface 5. An operation on shutter button 2 is detected through I/O interface 15 by CPU 12, and counting operation of counter 6 is executed through I/O interface 15.

The image pick-up system 10 includes an optical lens 3, an image pick-up device such as a CCD (Charge Coupled Diode) or a CMOS (Complementary Metal Oxide Semiconductor) sensor, and a peripheral circuit thereof When the image pick-up device is a CCD, for example, the peripheral circuit includes a CDS (Correlated Double Sampling) circuit, a V driver and an A/D converting circuit. In the image pick-up system 10, optical information input through optical lens 3 is converted by the image pick-up device and the peripheral circuit to an electric signal and output.

Image signal processing circuit 11, image compression/decompression circuit 13, I/O interface 15, CPU 12, memory controller 17 and PC interface 5 are generally contained in an LSI referred to as a DSP (Digital Signal Processing) apparatus. The DSP has a function of performing image processing at an image signal processing circuit based on the electric signal from image pick-up system 10, converting the image data to a standardized format of JPEG, for example, at image compression/decompression circuit 13, and storing the result in image memory 20. By adding or deleting internal component circuits of the DSP, functions of digital camera 1 can be added or deleted.

In the present embodiment, coding logic circuit 14 and ID storing apparatus 16 are contained as additional functions of the DSP. It is not always necessary, however, to incorporate these functions, provided that the configuration of digital camera 1 has functions corresponding to coding logic circuit 14 and ID storing apparatus 16. Further, in addition to the functions mentioned above, the DSP may contain a circuit that enables additional function of the digital camera such as an LCD controller, a microcomputer or a memory card controller, and functions of the digital camera such as image compression/decompression circuit 13 may be deleted.

Coding logic circuit 14 is a circuit for performing data conversion of the picked-up image data using the coding key stored in advance in ID storing apparatus 16. This logic circuit has a function of decoding using the same coding key as that of the decoding logic circuit 352 contained in the server apparatus. When the coding logic circuit 14 is an addition logic, for example, the decoding logic circuit 352 is a subtraction logic circuit. An LSI containing the coding logic circuit 14 should preferably be implemented by a tamper resistant apparatus, in order to prevent unauthorized replica.

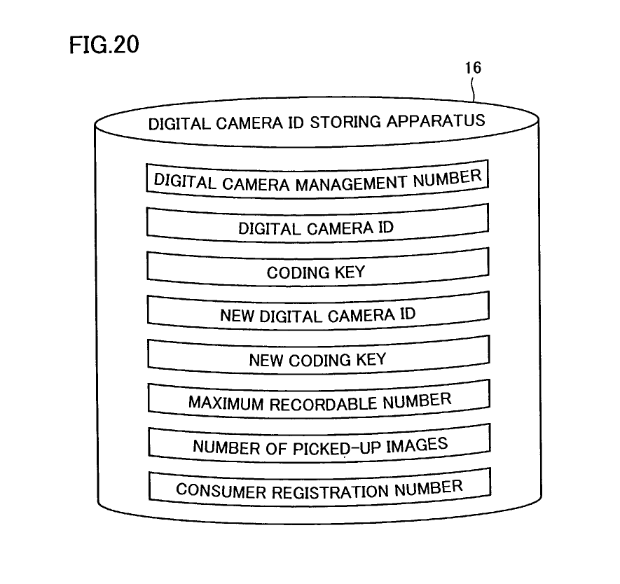

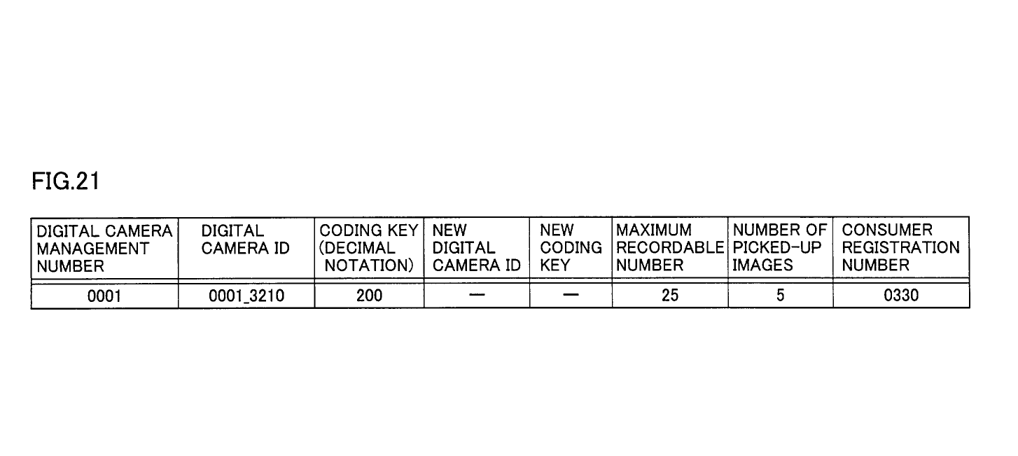

ID storing apparatus 16 stores the digital camera management number, the digital camera ID, the coding key, a new digital camera ID, a new coding key, the maximum recordable number, number of picked-up images and a consumer registration number, as shown in FIG. 20. Further, ID storing apparatus 16 is implemented by a non-volatile, data rewritable memory device, such as a flash memory, as shown in FIG. 21.

Further, referring to FIGS. 20 and 21, the digital camera management number consists of a numeral of one digit, for identifying digital camera 1. The digital camera management number is unique to each digital camera 1, and digital cameras 1 never have the same number.

The digital camera ID consists of the digital camera management number and a numeral of n digits for identifying the digital camera 1, which is recorded in ID storing apparatus 16 in digital camera 1, when digital camera 1 is shipped. When digital camera 1 is recycled with the image data erased, the digital camera ID and the coding key are prepared by digital camera ID preparing circuit 353 and coding key preparing circuit 354 of server apparatus 300, and distributed to the digital camera 1. The distributed digital camera ID and the coding key are stored in ID storing apparatus 16. Each digital camera 1 is thus associated with the digital camera ID, and therefore data transmission/reception between each of the server apparatus 300, sales side terminal 100 and digital camera 1 becomes possible.

The coding key consists of numerals of m digits, and it is recorded in ID storing apparatus 16 (see FIG. 19) in digital camera 1, when digital camera 1 is shipped to the user. The numeral of m digits is used as a keyword for encoding and decoding image data.

The new digital camera ID refers to the data constituting the digital camera ID that is updated when the picked-up data recorded in digital camera 1 are deleted and the digital camera 1 is recycled.

The new coding key refers to the data constituting a different coding key updated when the picked-up data recorded in digital camera 1 are deleted and digital camera 1 is recycled.

The maximum recordable number represents maximum number of image data that can be recorded in digital camera 1, and it is recorded in ID storing apparatus in the digital camera at the time of shipment of the digital camera. The maximum recordable number is set based on image data capacity per one image of digital camera 1 and the capacity of image memory 20 of digital camera 1.

The number of picked-up images refers to the number of images picked-up by the digital camera 1 under the (present) digital camera ID, which is counted up one by one every time one image is picked-up. The number of picked-up images is an example of items used for managing wear-out parts of digital camera 1. The items for managing the wear-out parts are not limited thereto, and the number of use of the electric flash or the number of erasure of image data may be used. Further, the number of use of a plurality of items of the wear-out parts used in digital camera 1 may be managed, and the degree of wear of all the wear-out parts in digital camera 1 may be managed based thereon.

The information stored in ID storing apparatus 16 of digital camera 1 is for assisting management of digital camera by server apparatus 300, and other information may be stored.

The consumer registration number refers to a code that can be registered by the user at the time of use of the digital camera, and it is input through operation buttons 7A to 7C, for example. In the digital camera 1, a positive number of 4 digits, for example, is stored as the consumer registration number, in ID storing apparatus 16. The consumer registration number serves as a secret identification number, for preventing unauthorized reading of data by a person other than the registered user. The consumer registration number may not be used in digital camera 1.

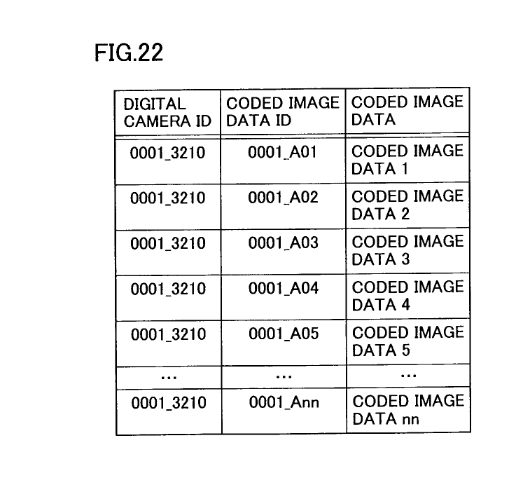

Referring to FIG. 22, image memory 20 stores digital camera ID, coded image data ID and coded image data, associated with each other. Image memory 20 is implemented by a date rewritable memory device such as a flash memory.

The coded image data ID refers to data consisting of digital camera management number, a character A and a serial number from 1 to the maximum recordable number, which is recorded in image memory 20 in association with the coded image data, which will be described below.

The coded image data refers to the image data (see FIG. 12) coded by an operation on original image data using a coding key, by coding logic circuit 14. The coded image data is formed by combining image block data, with each image block data having 8 pixels×8 pixels. When the coded image data corresponds to image data of 352 pixels×288 pixels, for example, it includes 44×36 pixel block data. The number of pixels constituting the image block data and the like are not limited to those mentioned in the present embodiment.

The value of each pixel of the coded image data is represented within the range of 0 to 255. The value of each pixel of the coded image data may vary in accordance with the image contained in the corresponding image data.

Program ROM 19 stores the main program. The main program is to realize photographing operation, and controls the overall digital camera 1. Therefore, the main program includes a plurality of programs, such as those listed below.

1. A program for encoding image data using the coding key, in coding logic circuit 14.

2. A program for transferring the digital camera management number, the digital camera ID and the coded image data to sales side terminal 100 connected through a PC interface.

3. A program for storing the new digital camera ID and the new coding key distributed from server apparatus 300 in ID storing apparatus 16.

4. A program for comparing the digital camera ID and the new digital camera ID.

5. A program for comparing the coding key and the new coding key.

6. A program for erasing, when a prescribed condition is satisfied, the coded image data stored in image memory 20 and the consumer registration number stored in ID storing apparatus 16.

7. A program for erasing, when a prescribed condition is satisfied, a data value of the new digital camera ID, by replacing the digital camera ID that has been stored in ID storing apparatus 16 with the data value of the new digital camera ID.

8. A program for erasing, when a prescribed condition is satisfied, a data value of the new coding key, by substituting the coding key that has been stored in ID storing apparatus 16 with the data value of the new coding key.

9. A program for storing the consumer registration number in ID storing apparatus 16, through key input.

10. A program for distributing, when the key-input consumer registration number matches the consumer registration number stored in ID storing apparatus 16, the data in image memory 20 to sales side terminal 100.

11. A program for operating/comparing the value of the number of picked-up images in ID storing apparatus 16, in accordance with the operation of digital camera 1.

The program may also include a known program essential to operate the digital camera, such as a program for operating the DSP to form image data, using shutter button 2 as a trigger, and a program for performing data transmission/reception to and from an external terminal through the PC interface 5.

Program ROM is a non-volatile, data rewritable memory device and implemented, for example, by a flash memory.

In the configuration described above, when an input signal from shutter button 2 is input through I/O interface 15 to CPU, optical information is converted by image picked-up system 10 including the image picked-up optical system to an electric signal, thereafter image processing is performed in image signal processing circuit 11, and thereafter, the image data is converted by image compression/decompression circuit to a standardized format such as JPEG. In the present specification, the image data of the general standard will be considered as the original image data.

Thereafter, the original image data is subjected to data conversion using the coding logic circuit 14 and the coding key stored in advance in ID storing apparatus 16, temporarily held in SDRAM 18 as a work memory, and stored as the coded image data in image memory 20. The coding logic circuit 14 is an operating circuit having two or more inputs, to which the value of the original image data and the coding key are input. When the coded image data is stored in image memory 20, the value of the data of the number of picked-up images recorded in ID storing apparatus 16 is incremented by “1”, which is compared with the value of the maximum recordable number. In response, the value indicated on counter 6 is counted up or counted down, one by one.

The image data stored in image memory 20 is transferred to an external terminal such as sales side terminal 100 through PC interface 5. The PC interface 5 is capable of transmission in compliance with a standard enabling bi-directional communication such as USB (Universal Serial Bus), IrDA (Infrared Data Association) or Bluetooth, and it also transmits/distributes data to ID storing apparatus 16. Image memory 20 may be incorporated in digital camera 1 or it may be an external recording medium.

[Configuration of Sales Side Terminal]

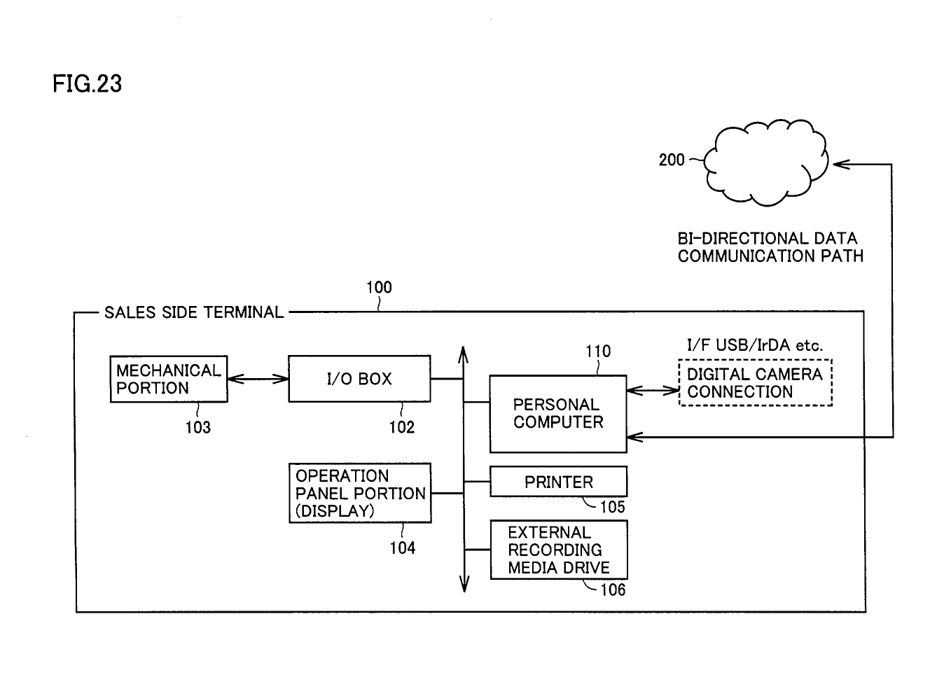

Referring to FIG. 23, sales side terminal 100 is implemented, for example, by a multimedia terminal. The terminal includes a personal computer 110, a mechanical portion 103, an I/O box 102, an operation panel portion (display) 104, a printer 105 and an external recording media drive 106, and is connected to data communication path 200 through personal computer 110.

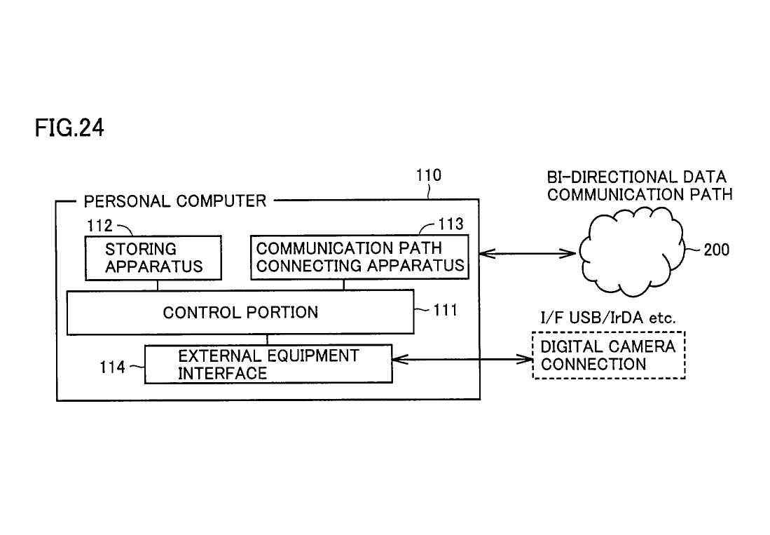

Referring to FIG. 24, personal computer 110 includes a communication path connecting apparatus 113, a storing apparatus 112, a control portion 111 and an external equipment interface 114. Further, as shown in FIG. 23, personal computer 110 controls I/O box 102, operation panel portion (display) 104, printer 105 and external recording medium drive 106, respectively.

Communication path connecting apparatus 113 is an apparatus for bi-directional communication, connected to server apparatus 300 through data communication path 200.

Storing apparatus 112 stores data received from server apparatus 300 and the like through communication path connecting apparatus 113, data received from digital camera 1 and the like through external interface 114, data input to operation panel (display) 104 of sales side terminal 100, and charge information data from mechanical portion 103. Storing apparatus 112 may be a hard disk contained in personal computer 110, or it may be a removable recording medium such as a magnetic disk.

Control portion 111 includes a central processing unit, not shown, a main program storing portion, and a temporary storing apparatus.

Control portion 111 controls, in accordance with the main program stored in the main program storing portion, communication path connecting apparatus 113, external equipment interface 114, data transmission/reception between equipment connected to data communication path in sales side terminal 100, and storing apparatus 112, respectively.

The central processing unit in control portion 111 performs control of various portions, selection of information, transfer of information, temporary storage of information, operation on information and so on, in accordance with the main program stored in the main program storing portion of control portion 111.

The temporary storing apparatus in control portion 111 is for temporarily holding results of processing, for example, by the central processing unit. For example, the apparatus temporarily stores the work file of the consumer selected image and the information work file.

Communication path connecting apparatus 113 is a control apparatus for bi-directional communication, connected to an external terminal through bi-directional data communication path 200.

The main program storing portion in control portion 111 stores the main program. The main program is to realize updating of data in storing apparatus 112 and data transmission/reception, and controls the overall personal computer 110. Therefore, the main program includes a plurality of programs such as those listed below.

1. A program for connection to server apparatus 300 through bi-directional data communication path 200, to perform bi-directional communication.

2. A program for storing information selected by the consumer at sales side terminal 100, such as information related to the print number and the data transfer destination address, in storing apparatus 112.

3. A program for transmitting/receiving information of the consumer selected image work file stored in storing apparatus 112 to/from server apparatus 300.

4. A program for transmitting/receiving information of the information work file stored in storing apparatus 112 to/from server apparatus 300.

5. Program for performing bi-directional communication with digital camera 1, through an interface such as the USB.

6. A program for performing bi-directional communication with other equipment constituting the sales side terminal 100, through a bus in the sales side terminal 100.

The main program may be stored in advance in the main program storing portion in control portion 111, or it may be recorded on a recording medium that is detachable, such as a floppy (R) disc. When the program is recorded on a detachable recording medium, the recorded program is read from the recording medium by a recording medium drive such as a floppy (R) disc drive, and temporarily stored in the main program storing portion.

The recording medium recording the program may be any medium that holds a program fixedly, including a tape such as a magnetic tape or a cassette tape, a magnetic disc such as a flexible disk or a hard disk, an optical disk such as a CD-ROM, MO, MD or DVD, an IC card such as a memory card, a card such as an optical card or a semiconductor memory such as a mask ROM or a flash memory. Further, the medium may be such a one that holds the program flexibly, for example, the program may be downloaded from the network. When the program is downloaded from the network as mentioned above, the program for downloading may be stored in advance in the server system, or installed in advance in the server system from a separate recording medium.

External equipment interface 114 is for performing data transmission/reception with external equipment such as digital camera 1, connected in accordance with a standard that enables bi-directional communication, such as USB, IrDA or Bluetooth.

Again referring to FIG. 23, mechanical portion 103 is implemented, for example, by a charging apparatus. Mechanical portion 103 transfers charging information as input data, through I/O box 102 to personal computer 110.

Operation panel portion (display) 104 is implemented by a display apparatus with an input, and has a function of displaying data stored in storing apparatus 112 of personal computer 110 and a key input function for operating sales side terminal 100. The display function and a key input function might be attained by separate apparatuses.

Printer 105 is for printing decoded image data, based on an instruction from personal computer 110.

Sales side terminal 100 may have any system configuration that allows personal computer 110 to be connected to server apparatus 300 through the bi-directional data communication path. For example, it may be installed for a consumer to connect to a dedicated Web site through personal computer 110, so as to transmit/receive image data.

In the above described configuration, when a user (consumer) connects the digital camera 1 to sales side terminal 100, the coded image data picked-up by the user is displayed on the operation panel portion (display). When the user selects an arbitrary image based on the display on the operation panel portion (display), the user enjoys the service in which output is obtained in an arbitrary form.

[Contents of Operation of Various Elements for Outputting Picked-Up Image]

First, contents of operations of various elements in the system will be described, taking an example in which a consumer uses the recycle digital camera system described above, picks-up an image with digital camera 1, records the thus prepared coded image data at a server apparatus 300 through sales side terminal 100, prints the decoded image data prepared by the decoding, and then erases the coded image data stored in digital camera 1.

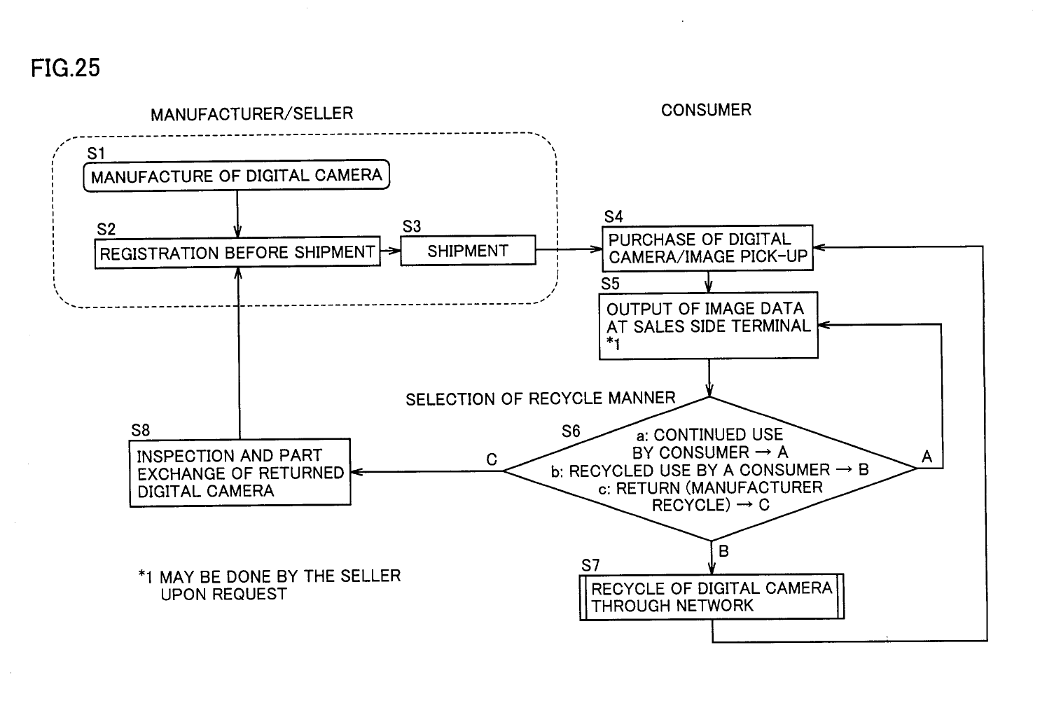

Referring to FIG. 25, the process will be described in which the digital camera 1 is manufactured, registered before shipment, and shipped.

Next, on the side of a manufacturer/seller of digital camera 1, a digital camera 1 is manufactured (S1), registration before shipment is performed (S2), and the digital camera 1 is shipped to the market (S3).

Thereafter, a consumer (user) purchases digital camera 1, and picks-up an image (S4). Thereafter, digital camera 1 is connected to sales side terminal 100 for image data output (S5). Connection of digital camera 1 to sales side terminal 100 may be performed by the side of a seller, upon request from the consumer.

Thereafter, the consumer side makes a selection of recycle manner.

When “continued use by a consumer” is selected, image pick-up using digital camera 1 is repeated, and in S5, digital camera 1 is connected to sales side terminal 100 for image data output.

When “recycled use by a consumer” is selected, stored information in digital camera 1 is all reset through bi-directional data communication bus 200 in step S7, the flow returns to S4, and a different consumer purchases digital camera 1 and picks-up images.

When “return (manufacturer recycle)” is selected, digital camera 1 is returned to the manufacturer/seller, inspection and/or exchange of parts is done in step S8, and registration before shipment is performed (S2).

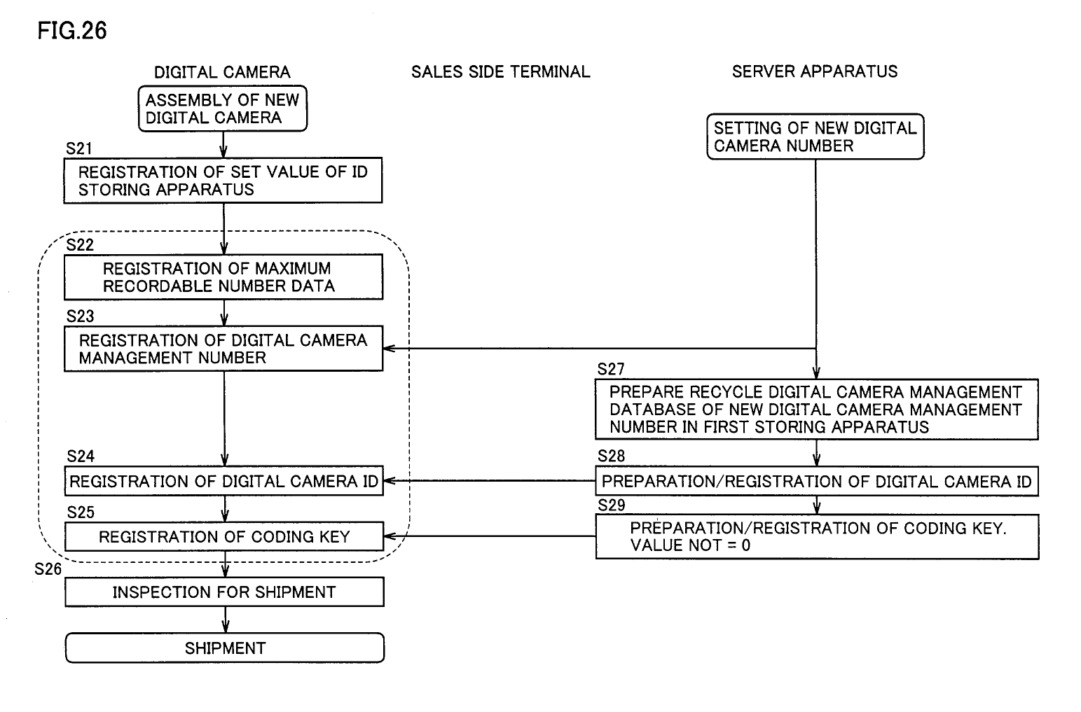

Here, referring to FIG. 26, detailed contents of the process of registration before shipment (S2) of digital camera 1 performed by the manufacturer/seller shown in FIG. 25 will be described.

When a digital camera 1 is assembled, what values are to be set in ID storing apparatus 16 is registered, in S21.

Thereafter, in S22, a revised value of maximum recordable number in ID storing apparatus 16 is registered. When image memory 20 is contained in digital camera 1, the maximum recordable number is calculated based on the capacity of image memory 20 and the size of one image data, and the value is registered. When the maximum recordable number is 25, “25” is recorded as the recordable number of ID storing apparatus 16.

Thereafter, in S23, the digital camera management number is registered in ID storing apparatus 16 of digital camera 1. The digital camera management number is a number to be stored in ID storing apparatus when digital camera 1 is manufactured. Only one number is allotted to one digital camera 1, and one number is never be allocated to two or more digital cameras 1.

In server apparatus 300, a recycle digital camera management database is prepared by a business proprietor, for managing each of the digital cameras 1 using the digital camera management number, in the first storing apparatus 310 (S27).

The digital camera ID and a coding key are prepared by server apparatus 300, and newly registered in the recycle digital camera management database (S28). After the digital camera ID is registered (S24) and the coding key is registered (S25) for digital camera 1, inspection before shipment including checking of operations and checking of successful network operation with server apparatus 300 through the sales side terminal is performed (S26), and the shipment process of S3 is thus performed.

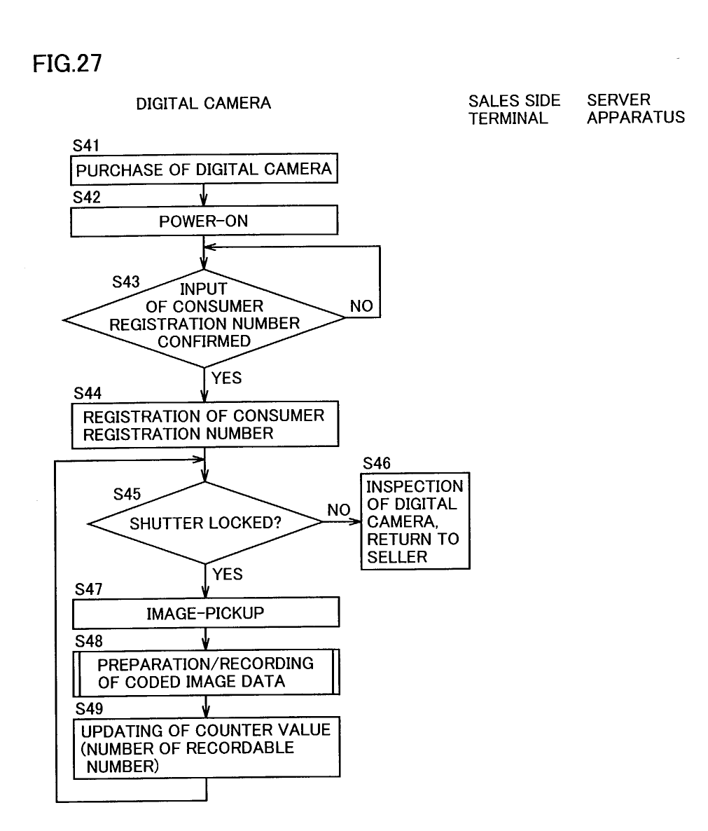

Next, referring to FIG. 27, detailed contents of the process for purchasing digital camera 1 and image pick-up by the consumer (S4) will be described.

A consumer purchases a digital camera 1 (S41), and thereafter, when a power switch 8 of digital camera 1 is operated, the power of digital camera 1 is turned ON (S42). The purchase in S41 refers to purchasing from the seller at a store or a through a vending machine such as an automatic vender. The purchase of S41 may be replaced by rental of a digital camera 1 by the manufacture/seller to the consumer with or without a deposit.

Thereafter, in S43, digital camera 1 receives an input of a consumer registration number, from the user. The user enters the number using operation buttons 7A to 7C, for example. When entrance of the consumer registration number is confirmed in S43, the consumer registration number is stored in ID storing apparatus 16 in S44. The consumer registration number is stored as a positive number of four digits, for example, and used as a secret identification number at the time of outputting the image data, for example. As the consumer registration number is used as the secret identification number, it is possible to prevent unauthorized reading of data by a person other than the registered user. The consumer registration number, however, may not always be used in digital camera 1.

In S45, functional check is performed, to see if the shutter of digital camera 1 is locked or not (image pick-up is not possible even when shutter button 2 is pressed). When mechanical failure such as shutter rock is found, the process proceeds to S46. In S46, a process such as returning the digital camera 1 to the manufacturer/seller is performed.

When mechanical failure is not found in the digital camera 1 in the step S45, image pick-up is performed using digital camera 1, in S47.

When an image is picked-up by digital camera 1, coded image data of the picked-up image is prepared in S48, the prepared data is stored in image memory 20, the number of picked-up images is implemented by 1 in ID storing apparatus 16 in S49 while the maximum recordable number is decremented by 1, and thereafter the process returns to S45.

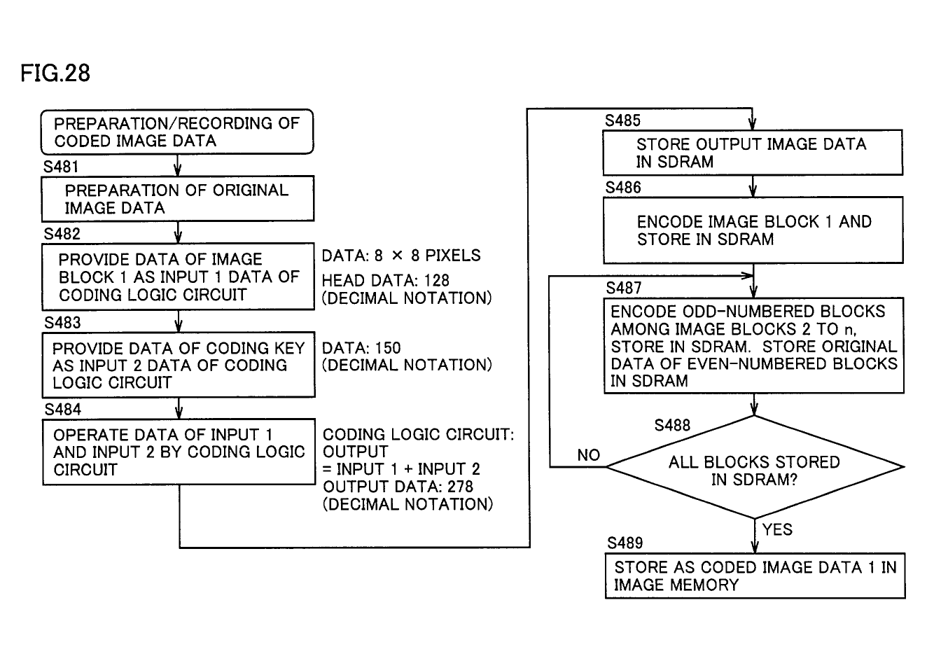

Preparation and recording of the coded image data in step S48 will be described in greater detail with reference to FIG. 28.

When a shutter button 2 of digital camera 1 is pressed, an image is picked-up. When the image is picked-up, in S48, an original image data is prepared by digital camera 1. In the preparation of original image data, operations well known for a general digital camera are performed, including an operation of converting optical information to an electric signal by an image pick-up system 10 including a pick-up optical system and an operation of performing image processing at an image signal processing circuit 11. Details of such operations will not be given here.

Thereafter, in digital camera 1, the original image data is encoded based on the coding key stored in ID storing circuit 26, at the coding logic circuit 14, and stored as coded image data 1 to n in image memory 20. Thus, the original image data is not identical with the coded image data. In the following description of coding of the image data in the present specification, the coding logic circuit 14 is a 2-input (input 1+input 2) adder circuit, the original image data consists of n image blocks with each block having 8×8 pixels and the coding key is a numerical value of 8 bits other than 0. These elements are examples only and not limiting. In the present specification, the image data is represented as decimal notation, as shown in FIGS. 11 and 12.

Again referring to FIG. 28, when the original image data is prepared in S481, in digital camera 1, original pixel data “128” at the head of image block data 1 (data constituting the first block among n image blocks) of the original image data is provided as input 1 of coding logic circuit 14 in S482, and coding key “150” is provided as input 2 of coding logic circuit 14, in S483.

Thereafter, in S484, an operation is performed on the data of input 1 and input 2, by coding logic circuit 14. In this operation the present embodiment, a sum of the numerical values of input 1 and input 2 is calculated. As a result of operation in S484, the coded pixel data corresponding to the head of image block data 1 of original image data will be “278”. The coded pixel data “278” as a result of the operation is stored in SDRAM18 in S485.

Thereafter, in step S486, such operations are successively performed on original image block 1, and results of operations are stored in SDRAM18.

Thereafter, in S487, only the image blocks having odd-number (image block 3, image block 5 . . . ) among n image blocks included in the original image data other than the image block 1 are subjected to encoding, and results are stored in SDRAM18. As to the image blocks having even-number of the original image data, the original image data are stored in SDRAM18 as they are.

In S488, when it is confirmed that storage of data of all the image blocks to SDRAM18 has been completed, the data stored in SDRAM18 is stored as the coded image data, in image memory 20 in S489. When the coded image data is stored in image memory 20, the contents stored in SDRAM18 are erased.

By such a process, it follows that the coded image data shown in FIG. 12 that corresponds to the original data shown in FIG. 11 comes to have blocks having the same values as the original image data (unhatched blocks in the figure) and blocks having values different from the original image data (hatched blocks in the figure).

In the present embodiment, referring to FIG. 12, coded and uncoded blocks are arranged alternately in the coded image data. The manner of coding, however, is not limited thereto. For example, only the central portion of the image data may be coded. When the image data is partially encoded in this manner, it is possible for the user to visually recognize the coded image data and to determine whether the coded image data is to be decoded or not. The coded image data may be prepared by coding the original image data entirely.

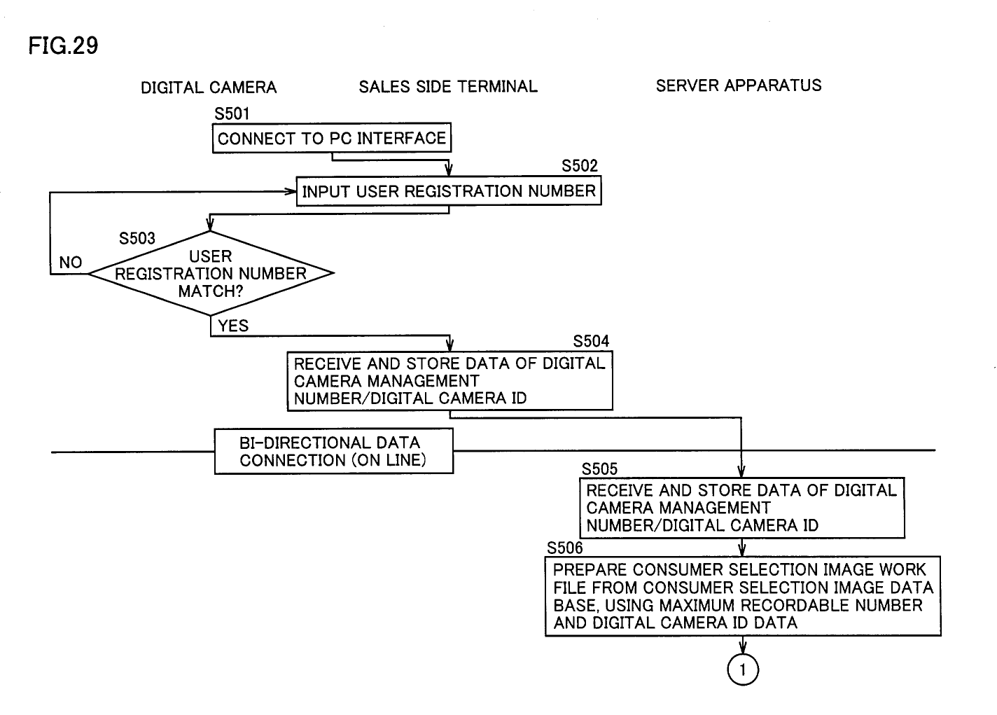

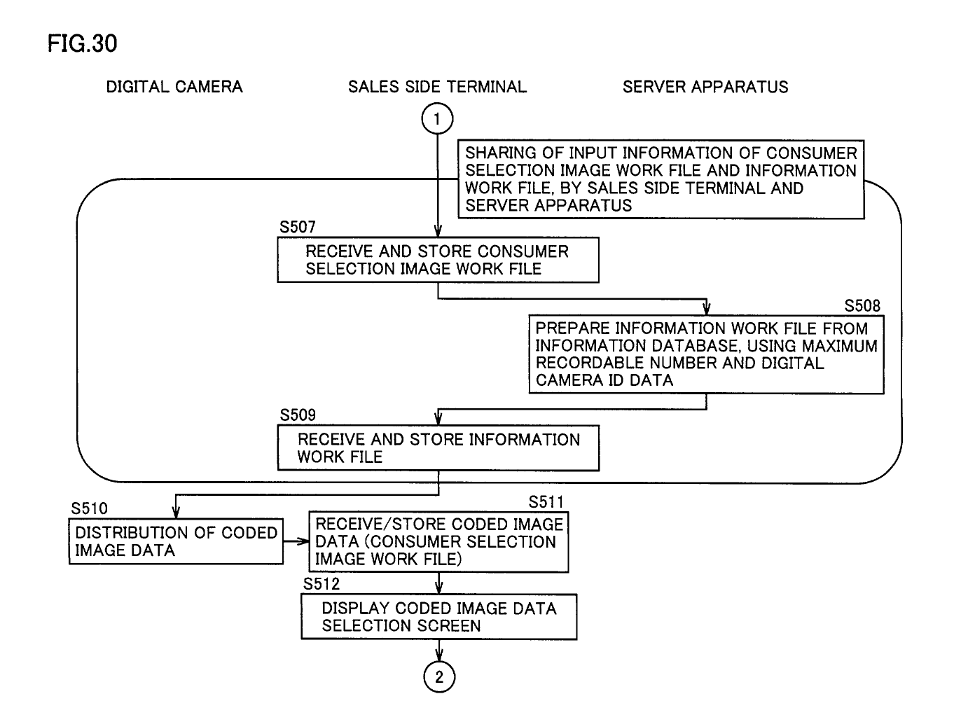

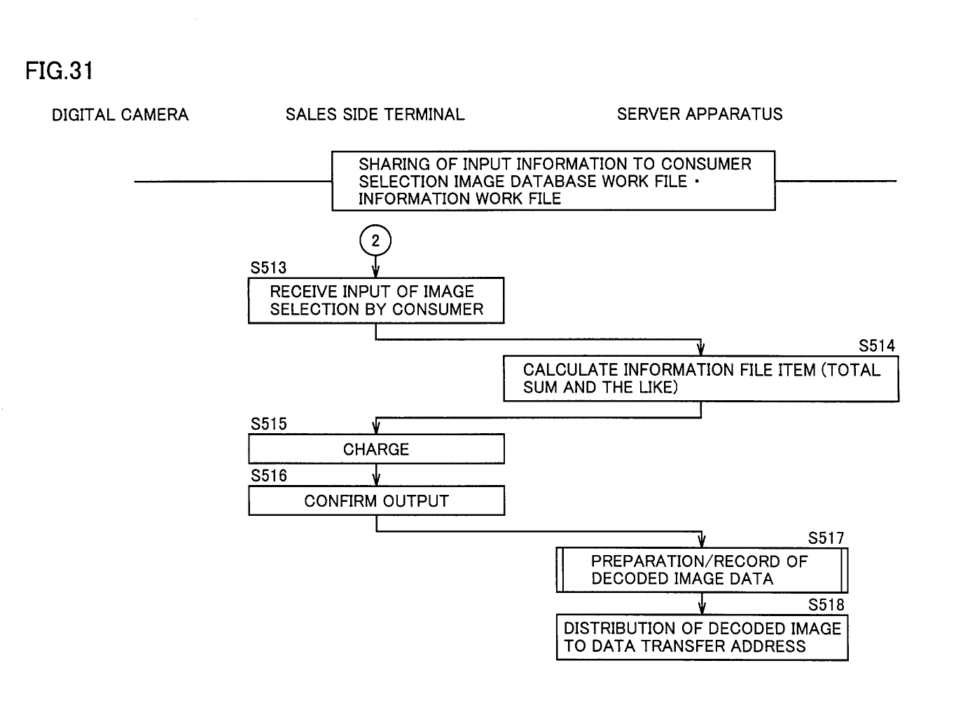

Next, referring to FIGS. 29 to 31, output of image data at the sales side terminal (S5) will be described in greater detail.

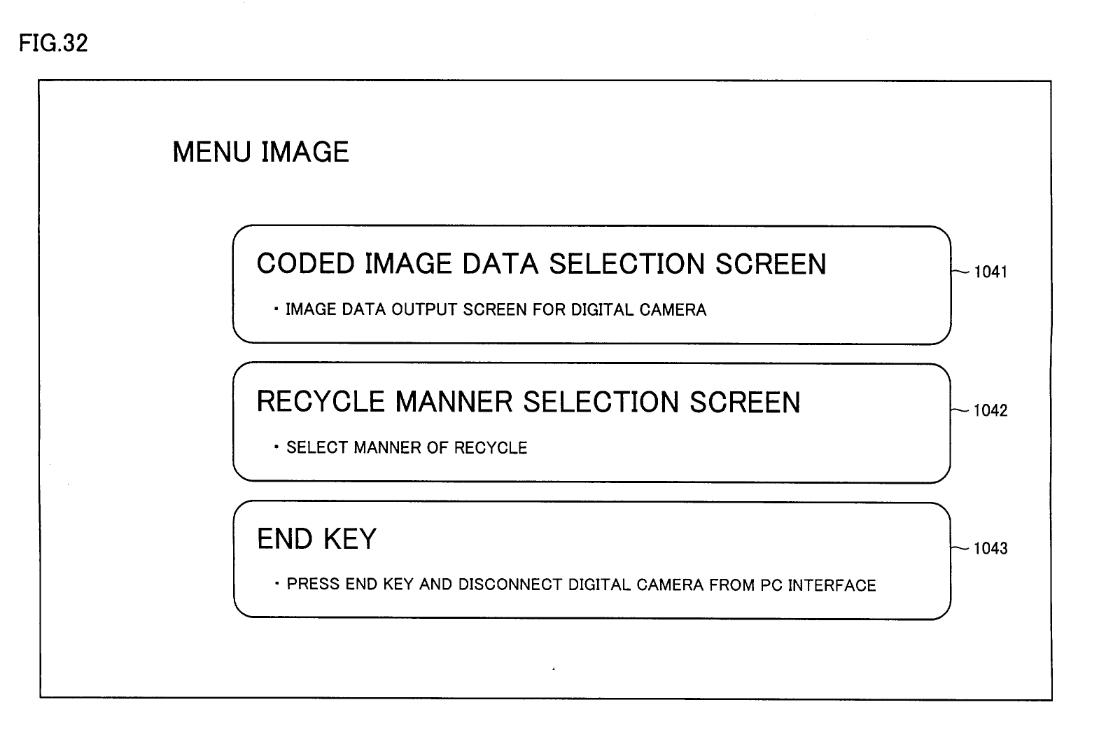

When the image data is output, first, in S501, a PC interface 5 of digital camera 1 is connected to personal computer 110 of sales side terminal 100. Accordingly, an image such as shown in FIG. 32 appears on operation panel portion (display) 104 of sales side terminal 100.

In the image shown in FIG. 32, there are buttons 1041 to 1043, indicating three menu items, “coded image data selection screen”, “recycle manner selection screen” and “end key”. When the button 1041 is touched or the button is operated, a process for selecting the coded image data starts. When button 1042 is touched or the button is operated, a process for selecting the recycle manner of digital camera 1 starts. When button 1043 is touched or the button is operated, the process for terminating the process related to the digital camera 1 at sales side terminal 100 starts.

When button 1041 is operated to output coded image data, the process proceeds to S502.

In S502, the consumer registration number entered through operation panel 104 or the like of sales side terminal 100 is input to digital camera 1.

In S503, the input consumer registration number is compared with the consumer registration number of ID storing apparatus 16, in digital camera 1. When the numbers match, the process proceeds to S504.

In S504, the digital camera management number and digital camera ID are transferred to sales side terminal 100. Here, in accordance with a program in sales side terminal 100, sales side terminal 100 and server apparatus 300 are connected through bi-directional data communication pass 200, to establish on-line connection. Then, sales side terminal 100 distributes the digital camera management number and the digital camera ID to server apparatus 300.

In response, server apparatus 300 receives the digital camera management number and a digital camera ID (S505), and based thereon, the server prepares a list of the corresponding consumer selection image database and a list of information file (S506). Server apparatus 300 distributes the prepared list to sales side terminal 100. Sales side terminal 100 receive the list, and records the received lists in storing apparatus 112 in personal computer 110 (S507).

At sales side terminal 100, it is possible for the user to enter data, to the list of the consumer selection image database recorded in storing apparatus 112. The input data is automatically distributed to server apparatus 300. In server apparatus 300, various operations are performed based on the data input through sales side terminal 100, and a list data of the information file is prepared (S508). The list data of the information file operated at server apparatus 300 is automatically distributed to sales side terminal 100, and reception process is performed at sales side terminal 100 (S509).

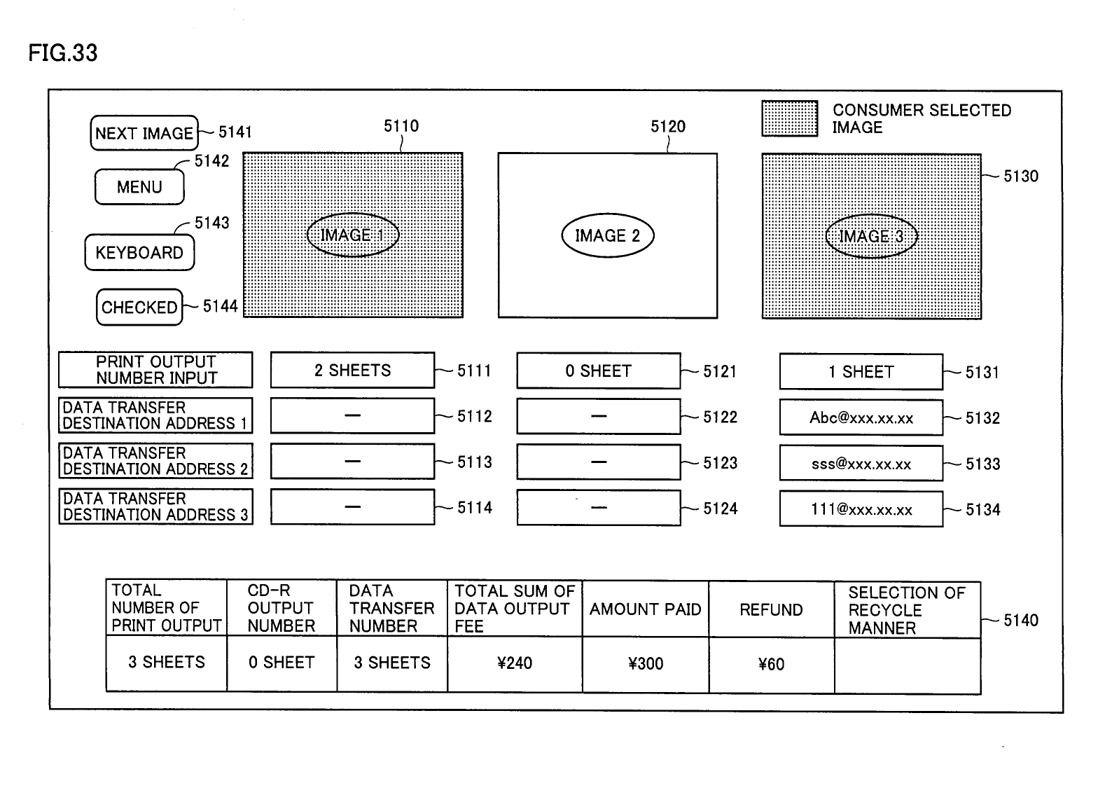

Then, digital camera 1 distributes coded image data 1 to n through PC interface 5 to sales side terminal 100 (S510), and on the sales side terminal, reception process is performed (S511). Then, sales side terminal 100 provides an image allowing the user to select which of the images among the coded image data is to be decoded (coded image data selection screen) (S512). FIG. 33 shows the coded image data selection screen.

At image display portions 5110, 5120 and 5130 of the coded image data selection screen, images are displayed based on the coded image data. The images in image display portions 5110, 5120 and 5130 have image data partially encoded, and therefore, the images are displayed partially modified.

On image setting portions 5111 to 5114, 5121 to 5124 and 5131 to 5134 of coded image data selection screen, items to be set for the images displayed on image display portions 5110, 5120 and 5130, respectively, are displayed. Specifically, the number to be printed on photographic paper for each image selected by the user is displayed on image setting portions 5111, 5121 and 5131. Mail addresses as the image data transfer destination are displayed at image setting portions 5112 to 5114, 5122 to 5124 and 5132 to 5134. The image of which output in the form of a print and/or image data transfer is selected is displayed in a manner different from the non-selected images. For example, the selected image is highlighted, at the image display portions 5110, 5120 and 5130. In the example shown in FIG. 33, the images displayed on image display portions 5110 and 5130 are displayed in such a manner.

On the coded image data selection screen, only three images are displayed at one time, as shown in FIG. 33. When there are three or more images among the coded image data stored in storing apparatus 112, button 5141 is operated, to display other images.

The button 5141 is operated to display a menu for setting a manner of image output, for example.

The button 5143 is operated when a keyboard is to be displayed on operation panel portion (display) 104. This button is operated particularly when a mail address of the transfer destination of the image data is entered.

The button 5144 is operated when the user confirms inputs, for example, operated to have images of which output is set, displayed as a list.

Below the coded image data selection screen, a table 5140 is displayed. The table 5140 notifies, in the form of a table, the total number to be print-output, the amount calculated from the total number (the total sum of data output fee), amount paid by the user, and a refund to the user calculated based on the total sum of the data output fee and the amount paid by the user.

Through the screen such as shown in FIG. 33 of sales side terminal 100, the consumer selects which image is to be output in what manner by what number, and the contents input in this manner are received by the sales side terminal (S513).

The information received by sales side terminal 100 is distributed to server apparatus 300. In response, server apparatus 300 calculates the total sum for the image output input through sales side terminal 100, and transmits the calculated amount to sales side terminal 100. The thus distributed total sum is displayed on table 5140 of FIG. 33.

The display of the total sum on table 5140 means charging to the user (S515).

When payment of an amount equal to or higher than the total sum on table 5140 by the user through mechanical portion 103 is confirmed at sales side terminal 100 (S516), reception of the amount of money is transmitted to server apparatus 300. In response to the contents of the images shown in FIG. 33, server apparatus 300 prepares decoded image data corresponding to the coded image data, and the data is recorded on photographic paper or to a medium such as CD-R (S517). Alternatively, the image data is transferred (S518).

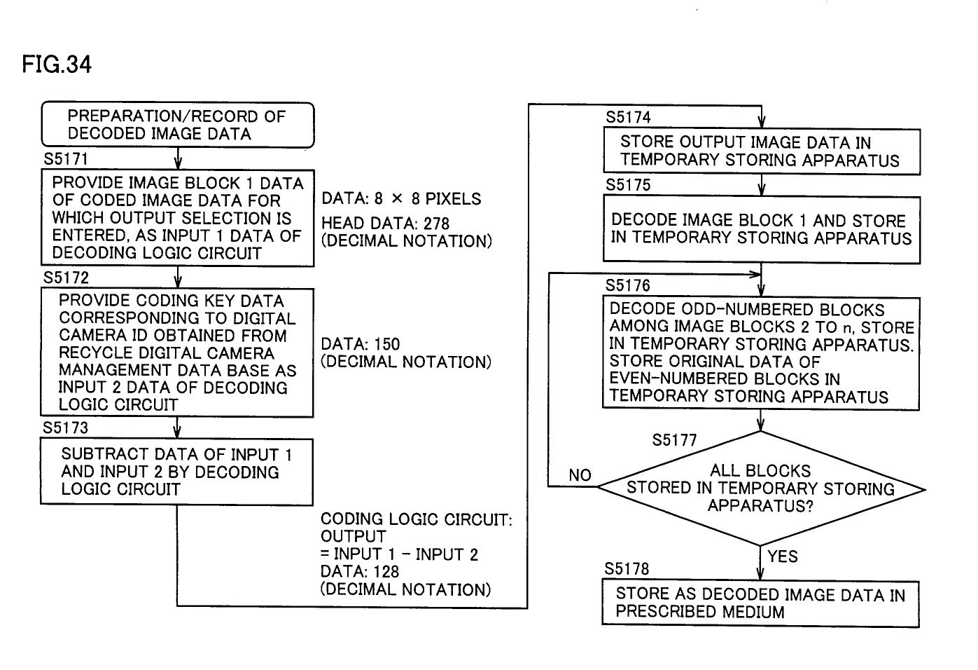

The process in step S517 will be described with reference to FIG. 34.

In decoding the image data, first, in server apparatus 300, the original pixel data “128” at the head of image block data 1 (data constituting the first block of n image blocks) of coded image data is provided as input 1 of decoding logic circuit 352, and in S5172, the coding key “150” is provided as input 2 of decoding logic circuit 352.

In the present embodiment, the decoding logic circuit 352 is a 2-input (input 1+input 2) subtraction circuit. The coded image data consists of n image blocks with each image block having 8×8 pixels as described above, and the coding key is a numerical value of 8 bits other than 0.

In S5173, data of input 1 and input 2 are operated by decoding logic circuit 352. In this operation of the present embodiment, a value is calculated by subtracting input 2 from input 1. As a result of operation in S5173, the coded image data corresponding to the head of image block 1 of coded image data comes to be “128”, which is the same value as the original image data. In S5174, the decoded pixel data “128” as a result of operation, is stored in temporary storing apparatus 356.

In S5175, such operations are performed successively on image block 1 of coded image data, and results of operations are stored in temporary storing apparatus 356.

In S5176, only the image blocks having odd-number (image block 3, image block 5 . . . ) among n image blocks included in coded image data other than image block 1 are decoded, and the results are stored in temporary storing apparatus 356. As to the image blocks having even-number of the coded image data, the coded image data are stored as they are in temporary storing apparatus 356.

When it is confirmed in S5177 that storage of data of all image blocks in temporary storing apparatus 356 has been completed, the data stored in temporarily storing apparatus 356 is recorded to a medium designated by the user, as decoded image data, in S5178. When the decoded image data is stored in the medium, the contents stored in the temporarily storing apparatus 356 are erased.

In the above described process, it is possible for the user to pick-up an image by a digital camera, and to have desired image data among the image date coded by digital camera 1, output in a desired form.

The recycling of digital camera 1 in the manner selected in S6 of FIG. 25 will be described.

At sales side terminal 100, when a button 1042 shown in FIG. 32 is operated, the recycle manner selection screen appears, which is an image enabling the user to select the manner of recycling digital camera 1, on operation panel portion (display) 104.

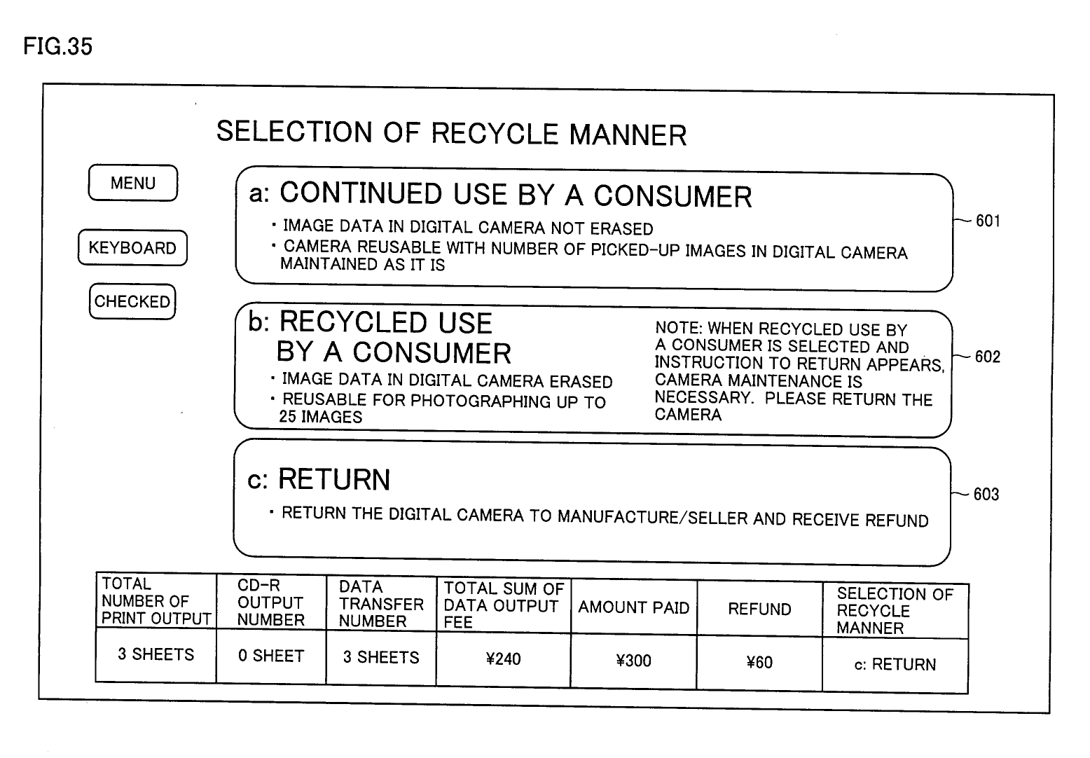

Referring to FIG. 35, on the recycle manner selection screen, there are buttons 601, 602 and 603 for selecting “continued use by a consumer”, “recycled use by a consumer” and “recycle”, as the manner of recycling digital camera 1.

When the user operates button 601 and selects continued use by a user, the digital camera 1 is used continuously by the same user, as described with reference to FIG. 25.

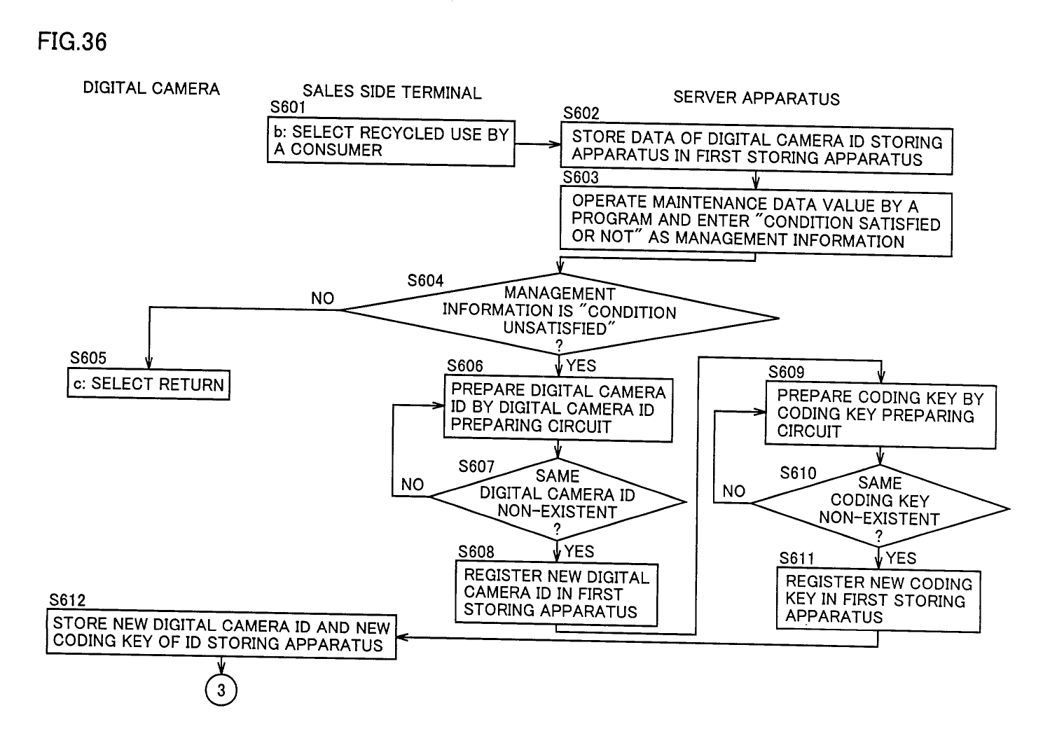

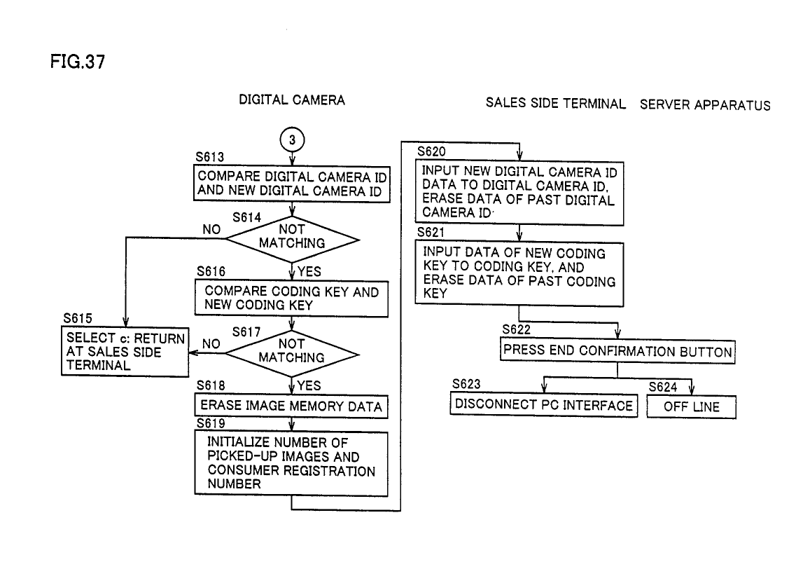

When the user operates button 602 and selects recycled use by a user, the recycling process of digital camera 1 through the network is performed as described with reference to FIG. 25. The recycling process will be described in greater detail, with reference to FIGS. 36 and 37.

When the information that recycled use by a consumer is selected is received at sales side terminal 100 (S601), server apparatus 300 stores the data stored in ID storing apparatus 16 of digital camera 1 that is presently connected to sales side terminal 100, in the first storing apparatus 310, in S602.

Thereafter, server apparatus 300 performs an operation in accordance with the main program on the maintenance data value in S603, so as to input whether management information (see FIGS. 4 to 6) is present/absent for the digital camera 1. The maintenance data value represents a reference value to determine whether maintenance of digital camera 1 is necessary or not. As an example, in the present embodiment, an accumulated number of picked-up images by the digital camera are used (see FIGS. 4 to 6).

When it is determined that there is the management information (condition satisfied), the processing by server apparatus 300 proceeds to S605, and transmits information to sales side terminal 100 so that only the recycle manner of “return” of digital camera 1 can be selected. Accordingly, in S8 (see FIG. 25), the camera 1 is inspected and/or have parts exchanged. When the management information is absent (condition unsatisfied), the process proceeds to S606.

In S606, a new digital camera ID is prepared by digital camera ID preparing circuit 353 of server apparatus 300. In S607, it is confirmed whether there is the same digital camera ID as the newly prepared digital camera ID. When such an ID exists, a different digital camera ID is prepared again in S606, and when such ID does not exist, the process proceeds to S608. In S608, the new digital camera ID is registered for the digital camera 1.

Then, in S609, in correspondence with the digital camera ID, a coding key is prepared by coding key preparing circuit 354. It is confirmed whether there is the same coding key as the newly prepared key, in S610: When such a key exists, a process for preparing a different coding key is performed in S609, and if not, the process proceeds to S611. In S611, the new coding key for the digital camera 1 is registered in the first storing apparatus 310.

Then, server apparatus 300 have the new digital camera ID and the coding key stored in ID storing apparatus 16 of the digital camera 1, in S612.

In digital camera 1, when a new digital camera ID and a new coding key are stored in S613, the digital camera ID that has been allotted to the present is compared with the new digital camera ID. When the IDs are determined to be different in S614, the process proceeds to S616. In S616, the coding key that has been used to the present is compared with the new coding key, in digital camera 1. When the keys are determined to be different in S617, the process proceeds to S618. When the IDs or the keys are determined to be the same in S614 or S617, a display is given in S615 to request returning, on the operation panel portion (display) 104 of the sales side terminal 100, asking the user to return the digital camera 1.

In S618, image data that have been recorded in image memory 20 are erased. In S619, the number of picked-up images and consumer registration number of digital camera 1 are initialized. In S620, the digital camera ID that has been used to the present and stored in ID storing apparatus 16 is erased, and in S621, the coding key that has been used to the present is erased.

When the processes of S618 to S621 described above are completed, a button asking confirmation of the end of a recycling process appears on the operation panel portion (display) 104. At sales side terminal 100, the operation on the button confirming the end is received in S622.

Thereafter, at sales side terminal 100, the digital camera 1 is disconnected and the recycling process ends, in S623. Server apparatus 300 disconnects sales side terminal 100, and the recycling process ends.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital camera recycle system, comprising
a digital camera and an information processing unit connectable to said digital camera; wherein
said digital camera includes an image pick-up optical system, an original image data preparing portion preparing an original image data by processing an image signal obtained at said image pick-up optical system, a coding data preparing portion coding the original image data to prepare coded image data, and a coded image data output portion outputting said coded image data to said information processing unit; and
said information processing unit includes a decoded data preparing portion decoding said coded image data, when a prescribed condition is satisfied.

2. The digital camera recycle system according to claim 1, wherein
said information processing unit includes a terminal apparatus connectable to said digital camera and a server apparatus provided with said decoded data preparing portion and connectable, through a network, to said terminal apparatus; and
said terminal apparatus includes an input portion inputting condition to decode said coded image data.

3. An information processing unit, connected to a digital camera including an image pick-up optical system, an original data preparing portion preparing an original image data by processing an image signal obtained at said image pick-up optical system, a coding data preparing portion preparing coded image data by coding the original image data, and a decoded data output portion outputting the coded image data to an external apparatus, said unit comprising:
receiving portion receiving said coded image data from said coded image data output portion; and
decoded data preparing portion decoding said coded image data, when a prescribed condition is satisfied.

4. The information processing unit according to claim 3, comprising
a terminal apparatus connectable to said digital camera, and a server apparatus connectable, through a network, to said terminal apparatus and having said decoded data preparing portion; and
said terminal apparatus has an input portion for inputting condition for decoding of said coded image data.

5. The information processing unit according to claim 4, wherein
said decoding data preparing portion includes a decoding logic circuit.

6. The information processing unit according to claim 5, wherein
said decoding logic circuit is formed of a tamper resistant apparatus.

7. The information processing unit according to claim 3, further comprising
coding key preparing portion for forming a coding key, used for encoding in said digital camera and decoding by said decoded data preparing portion.

8. The information processing unit according to claim 3, further comprising:
a first database storing a first digital camera information including information for distinction from other said digital cameras; and
a digital camera information updating portion updating said first digital camera information.

9. The information processing unit according to claim 8, wherein
said first digital camera information is information inherent to each said digital camera and includes second digital camera information which is invariable even when said first digital camera information is updated.

10. The information processing unit according to claim 8, wherein
said digital camera includes a coded image data storing portion storing coded image data;
said digital camera information updating portion updates said first digital camera information in response to erasure of all the contents stored in said coded image data storing portion;
said coding key preparing portion prepares said coding key and transmits the prepared said coding key to said digital camera in response to erasure of all the contents stored in said coded image data storing portion; and
said digital camera information preparing portion transmits prepared said digital camera information to said digital camera in response to erasure of all the contents stored in said coded image data storing portion.

11. The information processing unit according to claim 8, further comprising:
a second database storing information selected by the user related to an output of image data obtained by said digital camera;
a third database storing information related to image data output fee of the image data obtained by said digital camera; and
a fourth database storing information related to output fee when output is made in accordance with information selected by the user related to the output of image data obtained by said digital camera, calculated based on the information stored in said second database and the information stored in said third database.

12. The information processing unit according to claim 11, further comprising
a fee calculating portion for calculating information related to output fee when output is made in accordance with information selected by the user in relation to output of the image data obtained by said digital camera, based on the information stored in said second database and information stored in said third database.

13. A digital camera, comprising:
an image pick-up optical system;
an original data preparing portion preparing original image data by processing an image signal obtained by said image pick-up optical system; and
a coded data preparing portion for preparing coded image data, by encoding said original image data.

14. The digital camera according to claim 13, wherein
said coded data preparing portion is implemented by a tamper resistant apparatus.

15. The digital camera according to claim 13, further comprising
a transmitting portion for transmitting said coded image data to an external apparatus.

16. The digital camera according to claim 15, further comprising
an identification information storing portion storing information for identifying each digital camera; wherein
said transmitting portion transmits said coded image data to the external apparatus, on condition that information identifying the digital camera stored in said identification information storing portion is entered.

17. The digital camera according to claim 16, wherein
contents stored in said identification information storing portion is rewritable when a prescribed condition is satisfied.

18. The digital camera according to claim 17, wherein contents stored in said identification information storing portion is rewritable every time said prescribed condition is satisfied.

19. The digital camera according to claim 16, wherein
said information identifying each digital camera includes digital camera management information specifying the digital camera, a digital camera ID updated when a specific condition is satisfied, a coding key used of preparation of said coded image data and for decoding, and maximum recordable number of said digital camera.

20. The digital camera according to claim 16, provided as ready to use by a user, with said information for identifying each digital camera stored in said identification information storing portion.

21. In a system including a digital camera and an information processing unit connectable to said digital camera, a method of recycling a digital camera, comprising the steps of:
generating original image data by processing an image signal obtained by an image pick-up system of the digital camera, in said digital camera;
encoding said original image data, in said digital camera; and
decoding said coded image data when a prescribed condition is satisfied, in said information processing unit.
